(19) United States
(12) Patent Application Publication
(10) Pub. No.: US 2024/0065456 A1
(43) Pub. Date: Feb. 29, 2024

(54) Peg Hook Bracket

(71) Applicant: Fasteners for Retail, Inc., Twinsburg, OH (US)

(72) Inventors: Keith Eden, Loves Park, IL (US); Brian James Krall, Willoughby, OH (US); Robert Louis Northrup, JR., Aurora, OH (US)

(73) Assignee: Fasteners for Retail, Inc., Twinsburg, OH (US)

(21) Appl. No.: 18/447,277

(22) Filed: Aug. 9, 2023

Related U.S. Application Data
(60) Provisional application No. 63/373,779, filed on Aug. 29, 2022.

(51) Int. Cl. A47F 5/00

(52) U.S. Cl. CPC A47F 5/0006

(57) ABSTRACT

A bracket for a display unit includes a retainer. The retainer includes a front surface and is operable to selectively interface with a display unit. The bracket includes a coupler attached to the front surface of the retainer. The coupler includes a socket having a first receptacle defining a first width and a second receptacle defining a second width different than the first width.

### CROSS REFERENCE TO RELATED APPLICATION

This U.S. patent application claims priority under 35 U.S.C. § 119(e) to U.S. Provisional Application 63/373,779, filed on Aug. 29, 2022. The disclosure of this prior application is considered part of the disclosure of this application and is hereby incorporated herein by reference in its entirety.

### TECHNICAL FIELD

This disclosure relates to peg hook brackets and more specifically, to peg hook brackets for hanging wire hangers at a retail display unit.

### BACKGROUND

Brackets may be used to support wire hangers extending from vertical structure of a display unit so that various products and items, such as packaged foods, clothing, toys, and the like may be hung from the hangers and displayed in a retail setting.

### SUMMARY

An aspect of the disclosure provides a bracket for a display unit. The bracket includes a retainer including a front surface and operable to selectively interface with a display unit. A coupler is attached to the front surface of the retainer and includes a socket. The socket has a first receptacle defining a first width and a second receptacle defining a second width that is different than the first width.

Implementations of the disclosure may include one or more of the following optional features. In some implementations, the coupler includes a top side and a bottom side disposed on an opposite side from the top side. In those implementations, the socket extends from the top side of the coupler. In further implementations, the first receptacle extends from an opening in the top side of the coupler and the second receptacle extends from the first receptacle. The first width may be greater than the second width. In other further implementations, the coupler includes a first side attached to the front surface of the retainer and an opposite second side spaced apart from the front surface of the retainer by a first channel extending from the top side to the bottom side. In even further implementations, the bracket further includes a slot extending from the bottom side of the coupler and aligned with the socket. In additional even further implementations, the slot is defined by a first lower wall and a second lower wall disposed adjacent to the bottom side of the coupler. Optionally, the lower first wall is spaced apart from the bottom side of the coupler on the first side to define a second channel.

In some examples, the coupler is configured to receive a hanger. The hanger includes an upper arm that, with the hanger received at the coupler, extends along the socket of the coupler. The hanger includes a lower arm that, with the hanger received at the coupler, extends below the bottom side of the coupler. The hanger includes a connecting arm between the upper arm and the lower arm that, with the hanger received at the coupler, extends along the first channel and the slot.

Another aspect of the disclosure provides a bracket for a display unit. The bracket includes a retainer including a front surface and that is operable to selectively interface with a display unit. The bracket includes a coupler attached to the retainer. The coupler has a bottom side and a top side opposite the bottom side. The top side includes an opening and a first receptacle that extends from the opening toward the bottom side and that defines a first width. A second receptacle extends from the first receptacle toward the bottom side and defines a second width that is less than the first width. The coupler has a first side attached to the front surface of the retainer. A lower portion of the first side extends below the bottom side. The coupler includes a second side opposite the first side and spaced from the front surface of the retainer by a first channel that extends from the top side to the bottom side. The coupler has an abutment spaced from the bottom side by a second channel. This aspect may include one or more of the following optional features.

In some implementations, the coupler is configured to receive a hanger. The hanger includes an upper arm that, with the hanger received at the coupler, extends along one of the first receptacle or the second receptacle. The hanger includes a lower arm that, with the hanger received at the coupler, extends below the bottom side. The hanger includes a connecting arm between the upper arm and the lower arm and that, with the hanger received at the coupler, extends along the first channel and between the abutment and lower portion of the first side. In further implementations, the upper arm of the hanger defines a width that is greater than the second width and less than or equal to the first width, and the upper arm of the hanger extends along the first receptacle. In other further implementations, the upper arm of the hanger defines a width that is less than or equal to the second width, and the upper arm of the hanger extends along the second receptacle.

In some examples, the first receptacle and the second receptacle are connected. Optionally, the first receptacle includes a first set of protrusions extending from opposing side surfaces of the first receptacle, and the second receptacle includes a second set of protrusions extending from opposing side surfaces of the second receptacle. The abutment may cooperate with the lower portion of the first side to define a third channel aligned with and vertically spaced from the first receptacle and the second receptacle.

Yet another aspect of the disclosure provides a bracket for a display unit. The bracket includes a retainer including a front surface and that is operable to selectively interface with a display unit. The bracket includes a coupler attached to the retainer. The coupler has a top side including an opening and a first receptacle extending from the opening and defining a first width. The coupler has a bottom side opposite the top side and spaced from the front surface of the retainer by a first channel that extends from the top side to the bottom side. The coupler has a first side attached to the front surface of the retainer. A lower portion of the first side extends below the bottom side of the coupler. The coupler includes a second side opposite the first side and attached to the front surface of the retainer. The coupler includes an abutment spaced from the bottom side by a second channel and that, together with the lower portion, defines a third channel. This aspect may include one or more of the following optional features.

In some implementations, the coupler is configured to receive a hanger. The hanger includes an upper arm that, with the hanger received at the coupler, extends along the first receptacle. The hanger includes a lower arm that, with the hanger received at the coupler, extends below the bottom side of the coupler. The hanger includes a connecting arm between the upper arm and the lower arm that, with the hanger received at the coupler, extends along the first channel and the third channel. In further implementations, when the hanger is received at the coupler, the hanger is adjustable relative to the coupler between a secured position and an unsecured position. In the secured position, the upper arm extends along the first receptacle, the lower arm extends below the bottom side of the coupler, and the connecting arm extends along the first channel and the third channel. In the unsecured position, the upper arm extends along the top side between the first side and the second side, the lower arm extends along an outer side of the abutment opposite an inner side defining the third channel, and the connecting arm extends along a diagonal portion of the first channel and not along the third channel.

In some examples, a second receptacle extends from the first receptacle and defines a second width less than the first width. Optionally, the first receptacle includes a set of protrusions extending from opposing side surfaces of the first receptacle. The third channel may be aligned with and vertically spaced from the first receptacle.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a perspective view of an example of a bracket according to the present disclosure, where the bracket is configured for attachment at a display unit and supporting a hanger at a coupler of the bracket.

FIGS. 2 and 3 are side views of the bracket and hanger of FIG. 1.

FIG. 4 is a front perspective view of the bracket of FIG. 1.

FIG. 5 is a front elevation view of the bracket of FIG. 1.

FIG. 6 is an enlarged fragmentary view of the coupler of the bracket of FIG. 1.

FIG. 7 is a perspective view of the bracket and hanger of FIG. 1, with the hanger removed from the coupler of the bracket.

FIG. 8 is a perspective view of the bracket and hanger of FIG. 1, with the hanger partially received at the coupler of the bracket.

FIG. 9 is a perspective view of the bracket and hanger of FIG. 1, with the hanger fully received at the coupler of the bracket.

FIGS. 10A-10G include perspective, front, rear, left, right, top, and bottom views of the bracket of FIG. 1.

FIG. 11 is a perspective view of another example of a bracket according to the present disclosure, where the bracket is supporting the hanger at a coupler of the bracket and the bracket is interfacing with a peg board of a display unit.

FIG. 12 is a side view of the bracket and hanger of FIG. 11.

FIG. 13 is a perspective view of the bracket of FIG. 11.

FIG. 14 is a front elevation view of the bracket of FIG. 11.

FIG. 15 is a rear elevation view of the bracket of FIG. 11.

FIG. 16 is another perspective view of the bracket of FIG. 11.

FIGS. 17A-17G include perspective, front, rear, left, right, top, and bottom views of the bracket of FIG. 11.

FIG. 18 is a perspective view of the bracket and hanger of FIG. 11, with the hanger adjusted relative to the coupler to an unsecured or loose state.

FIGS. 19 and 20 are respective front and rear views of the bracket and hanger of FIG. 11, with the hanger adjusted relative to the coupler from the unsecured state toward a first partially secured state.

FIG. 21 is a perspective view of the bracket and hanger of FIG. 11, with the hanger further adjusted toward a second partially secured state to align the hanger with a receptacle of the coupler.

FIG. 22 is a perspective view of the bracket and hanger of FIG. 11, with the hanger in the secured state relative to the coupler.

FIGS. 23A-23G include perspective, front, rear, left, right, top, and bottom views of another example of a bracket according to the present disclosure.

FIGS. 24A-24G include perspective, front, rear, left, right, top, and bottom views of another example of a bracket according to the present disclosure.

FIGS. 25A-25G include perspective, front, rear, left, right, top, and bottom views of another example of a bracket according to the present disclosure.

FIGS. 26A-26G include perspective, front, rear, left, right, top, and bottom views of another example of a bracket according to the present disclosure.

Like reference symbols in the various drawings indicate like elements.

### DETAILED DESCRIPTION

When displaying items in a retail setting, brackets are commonly used to support wire hangers extending from an upright support structure, such as a wire grid wall, a peg board (i.e., a board or sheet having an array of apertures or holes formed therethrough) or the like. Items are hung from the wire hangers for unobstructed display and easy removal of the items from the display unit. Multiple items may be stacked or hung along each wire hanger to provide greater inventory storage at the display unit. Often, the brackets are disposed across the support structure in various patterns or irregular arrangements and/or in close proximity to one another so that many different products may be displayed at once, with the spacing of the brackets accommodating the sizes and shapes of the items at the display unit. The close proximity of the brackets, hangers, and items at the display may make it difficult or awkward to assemble the display unit, rearrange the items or brackets and hangers at the display unit, and restock items. For example, it may be difficult to adjust positioning of a bracket and hanger at the display unit without disturbing or otherwise affecting positioning of other items and brackets. Thus, it is desirable to provide a bracket or hanging assembly or system where the bracket is easily removable and/or adjustable at the display unit and the hanger is easily installed and secured at the bracket. Furthermore, the size and weight of items that may be hung from the hanger at the bracket necessitates a strong and durable design.

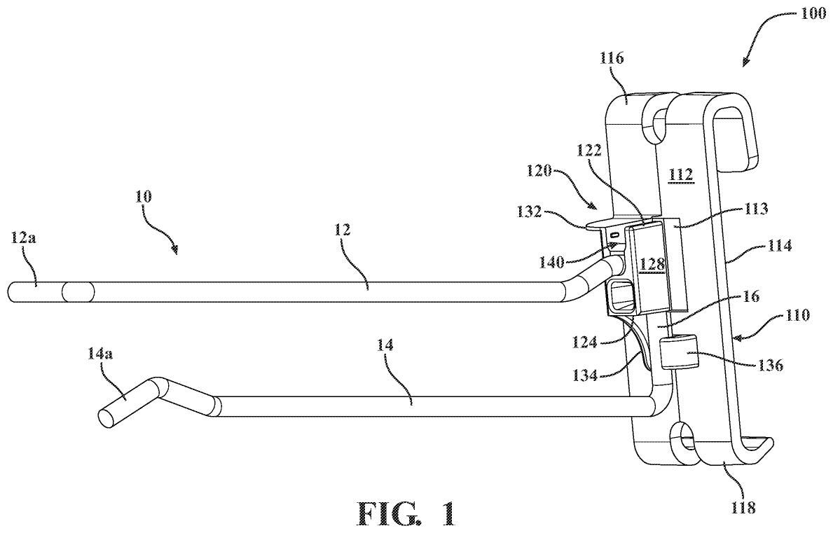

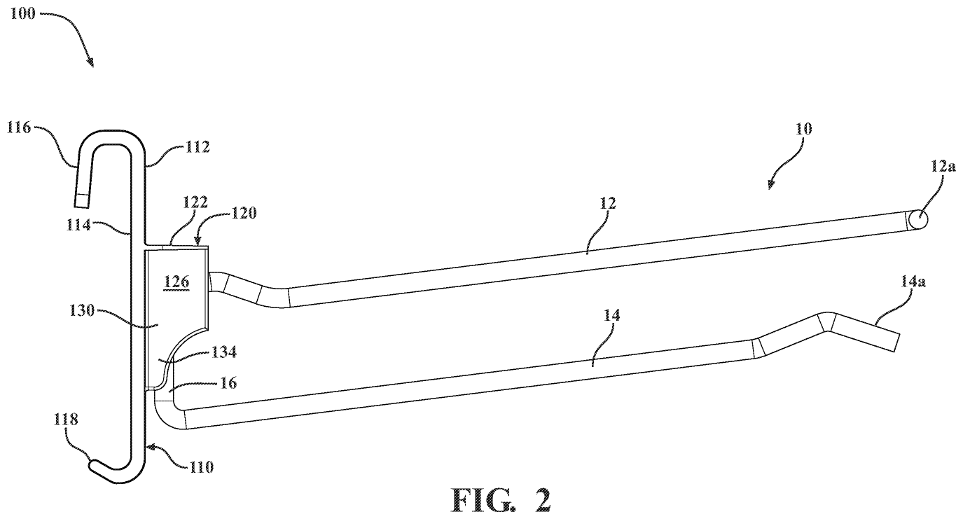

Referring to FIGS. 1-3, a bracket 100 configured to support a peg hook or hanger 10 at vertical structure of a display unit includes a retainer 110 and a coupler 120 attached to a front surface 112 of the retainer 110. The coupler 120 defines a socket 140 configured to receive and support the hanger 10 when the bracket 100 is positioned at the display unit. As described further below, the bracket 100 and coupler 120 are configured to allow for easy positioning of the hanger 10 at the bracket 100 and easy removal of the hanger 10 from the bracket 100. The hanger 10 (and any items hanging from the hanger 10) may be removed from and/or repositioned at the display unit with decreased risk of disturbing the position of the bracket 100 at the display unit or disturbing items supported by other brackets 100 at the display unit. Furthermore, the socket 140 is configured to support multiple different gauges or thicknesses of hanger so that a variety of hangers may be used interchangeably with the bracket 100.

As shown, the hanger 10 is a dual-arm hook that, when supported by the bracket 100, has an upper arm 12 that extends away from the display unit (such as to support a sign or pricing indicator) and a lower arm 14 that extends away from the display unit below the upper arm 12 (such as to support items disposed along the lower arm 14). The hanger 10 includes a connecting arm 16 connecting between the upper arm 12 and the lower arm 14 so that the hanger 10 may be removed and/or installed at the bracket 100 as a single unit. The upper arm 12 extends from an upper end of the connecting arm 16 and terminates at a retaining feature or terminal end 12a of the upper arm 12, such as a hook or curved portion of the upper arm 12. Similarly, the lower arm 14 extends from a lower end of the connecting arm 16 and terminates at a retaining feature or terminal end 14a of the lower arm 14, such as a stopper or bent portion of the lower arm 14.

When received in the socket 140 of the coupler 120, the upper arm 12 of the hanger 10 extends along the socket 140 (which is formed along an upper or top side 122 of the coupler 120), the lower arm 14 extends below the coupler 120 (i.e., below a lower or bottom side 124 of the coupler 120), and the connecting arm 16 extends between the upper arm 12 and the lower arm 14 and along a space between the coupler 120 and the front surface 112 of retainer 110. Thus, and as described further below, the coupler 120 of the bracket 100 is attached to the retainer 110 along only a first side 126 of the coupler 120 so that the hanger 10 may be inserted around the coupler 120 into position in the socket 140 via a space between an opposite second side 128 of the coupler 120 and the retainer 110. This allows for easy installation and removal of the hanger 10 at the bracket 100 without needing to remove the bracket 100 from the display unit. Additionally, any suitable hanger may be interchangeably received at the coupler 120 when the bracket 100 is positioned at the display unit.

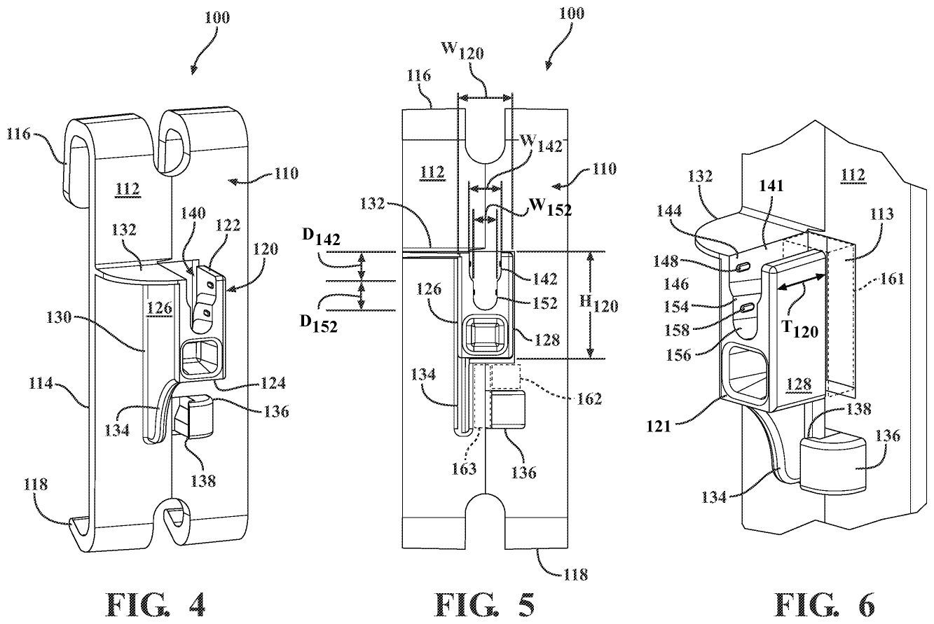

The retainer 110 may include any suitable attachment means for positioning the bracket 100 at the display unit. For example, and as shown in FIGS. 4 and 5, the retainer 110 may include an attachment means configured to engage horizontal wires of a wire grid wall display unit, where an upper retaining feature or hook 116 receives or wraps around a first, higher horizontal wire or rod and a lower retaining feature or hook 118 receives or wraps around a second, lower horizontal wire or rod. Alternatively, the retainer 110 may include one or more peg hooks configured to engage a peg board of a display unit, a slat hook configured to engage between slats of a slat wall of a display unit, a bracket configured to engage a track at a display unit, and the like. Thus, the retainer 110 allows for the bracket 100 to be selectively positioned and removed from vertical structure of the display unit.

The retainer 110 includes a rear surface 114 that engages or faces the support structure, and the front surface 112 is opposite the rear surface 114 and faces out from the support structure. The coupler 120 is positioned at the front surface 112 and an indentation or recess 113, or any other suitable surface shape or structure, may be disposed along the front surface 112 and aligned with or disposed at or near or behind the coupler 120 to provide clearance for the hanger 10 to be moved around the coupler 120 during installation.

The coupler 120 is attached to the front surface 112 of the retainer 110 so that, when the coupler supports the hanger 10 within the socket 140 of the coupler 120, load from the hanger 10 may be transferred through the coupler 120 to the retainer 110 and support structure of the display unit. In the illustrated example, the coupler 120 is integrally formed with the retainer 110, such as formed from a resistant plastic material.

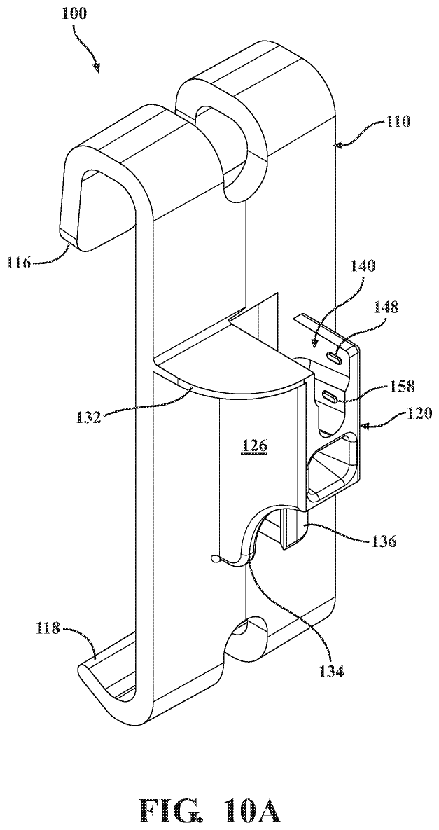

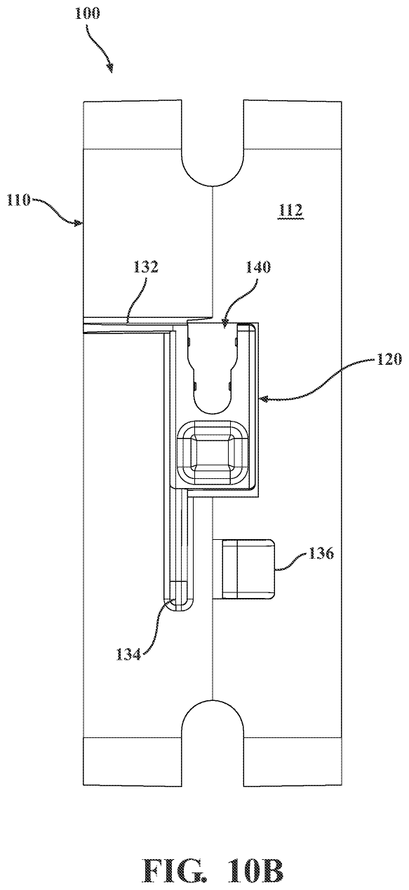

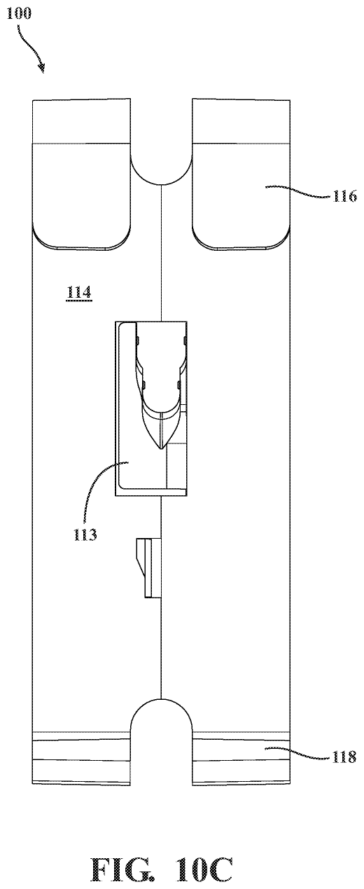

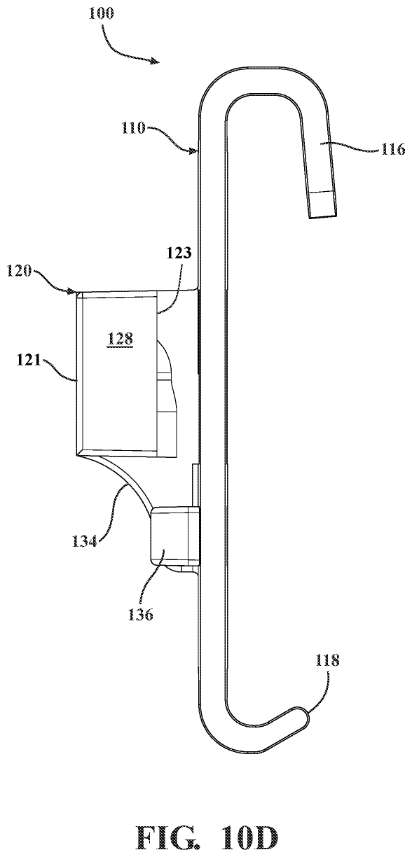

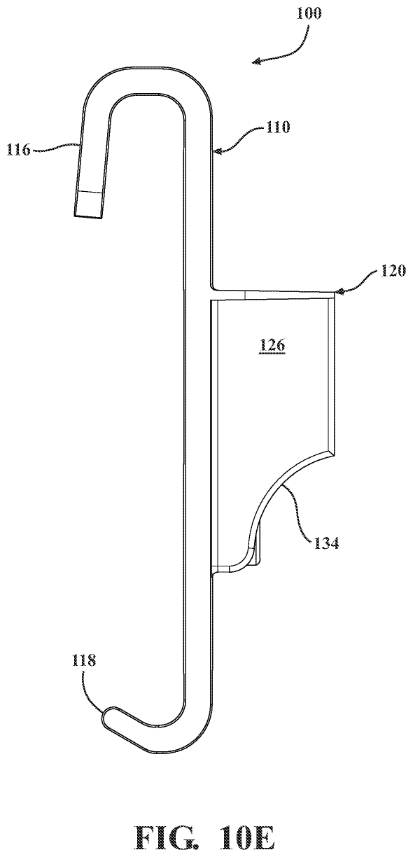

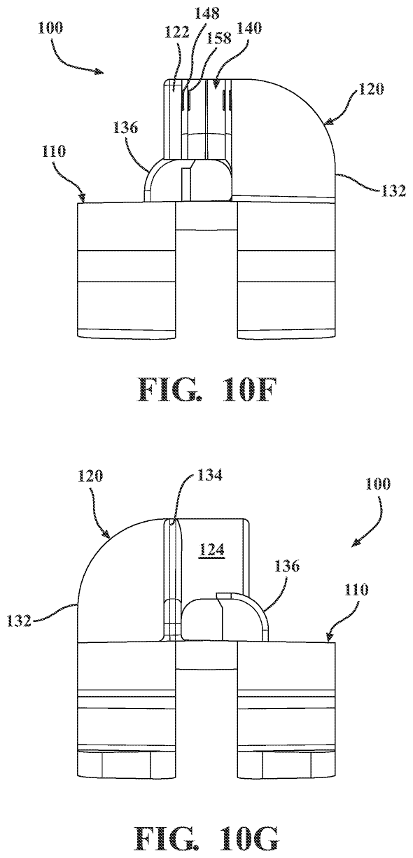

Referring to FIGS. 4-10G, the coupler 120 is shown as having a substantially rectangular shape, but it should be understood that the coupler 120 may have any suitable configuration necessary to support the hanger 10. The coupler 120 includes the first side 126 attached to or integrally formed with the front surface 112 of the retainer 110 and the second side 128 opposite the first side 126 and separated from the first side 126 by a width W₁₂₀ of the coupler 120. In other words, the width W₁₂₀ of the coupler 120 extends between the first side 126 and the second side 128. When the bracket 100 is positioned at the display unit, the first side 126 and the second side 128 are positioned substantially vertical and parallel to the support structure of the display unit. The top side 122 of the coupler 120 extends between the first side 126 and the second side 128 between upper edges of the first side 126 and second side 128. The bottom side 124 of the coupler 120, opposite the top side 122 and separated from the top side 122 by a height H₁₂₀ of the coupler 120, extends between lower edges of the first side 126 and second side 128. In other words, the height H₁₂₀ of the coupler 120 extends between the top side 122 and the bottom side 124.

A front surface 121 of the coupler 120 extends between the top side 122, the bottom side 124, the first side 126, and the second side 128 and faces away from the front surface 112 of the retainer 110. A rear surface 123 of the coupler 120 is opposite the front surface 121 and separated from the front surface 121 by a thickness T₁₂₀ of the coupler 120. The rear surface 123 faces the front surface 112 of the retainer 110 and is spaced from the retainer 110 by at least the recess 113. Because the edge of the second side 128 and the rear surface 123 of the coupler 120 are spaced from the front surface 112 of the retainer, the thickness T₁₂₀ of the coupler 120 is defined by the second side 128.

The first side 126 of the coupler 120 includes a connecting portion 130 that extends along the first side 126 and connects the coupler 120 to the front surface 112 of the retainer 110. Because the connecting portion 130 may be the only connection between the coupler 120 and the retainer 110, the connecting portion 130 is configured to withstand significant forces (e.g., from the load at the hanger 10 or from repeated removal and adjustment of the hanger 10 at the coupler 120). For example, the connector portion 130 in the illustrated embodiment includes a connecting rib or fin 132 extending from an upper edge of the first side 126 of the coupler 120 and outward along the front surface 112 of the retainer 110. Optionally, the first side 126 may include a series of ribs or fins 132 or other connecting structure along the first side 126 to further bolster the connection of the coupler 120 at the retainer 110. Furthermore, a gusset 134 of the first side 126 may extend below the bottom side 124 of the coupler and the gusset 134 may also be attached at the retainer 110 to support the coupler 120.

The bracket 100 may further include a lower wall or abutment 136 spaced from the gusset 134 of the first side 126 of the coupler so that, when the hanger 10 is positioned at the coupler 120, the connecting arm 16 extends between the gusset 134 of the first side 126 and the abutment 136 to align the upper arm 12 and the lower arm 14 vertically relative to one another. Moreover, an upper surface of the abutment 136 is spaced from the bottom side 124 of the coupler 120 so that, when the hanger 10 is being moved into position, a portion of the hanger 10 (e.g., the joint connecting the lower arm 14 and connecting arm 16) may pass between the abutment 136 and the bottom side 124 of the coupler 120. The abutment 136 may include a protrusion or lip 138 at a distal end opposite the front surface 112 of the retainer 110 to retain the hanger 10 in place when disposed at the bracket 100.

The socket 140 extends from an opening 141 along the top side 122 of the coupler 120 and provides a channel or receiver for the upper arm 12 of the hanger 10 to rest in when supported at the bracket 100. The socket 140 extends through the thickness T₁₂₀ of the coupler 120 so that the hanger 10 may wrap around and pass through the coupler 120 via the socket 140. As shown, the socket 140 includes a first channel or receptacle 142 having a depth D₁₄₂ that extends from the opening 141 in the top side 122 and toward the bottom side 124 along the thickness T₁₂₀ of the coupler 120. The first receptacle 142 is defined by opposing first receptacle side surfaces 144 that are spaced from one another by a width W₁₄₂ of the first receptacle 142. The first receptacle 142 is configured to accommodate a corresponding thickness or gauge of hanger 10 so that the hanger 10 may fit snugly within the first receptacle 142 (i.e., between the side surfaces 144) when disposed at the bracket 100. The first receptacle 142 also includes opposing or horizontal, convergent or partial, trough-like support surfaces 146 extending from respective lower ends of the side surfaces 144 so that the hanger 10 having a gauge corresponding to the first receptacle 142 rests on the support surfaces 146 and between the opposing side surfaces 144. Additionally, first receptacle retaining features 148, such as nubs or protrusions or bumpers, may extend from the opposing side surfaces 144 to vertically capture the hanger 10 between the respective retaining features 148 and support surfaces 146 of the first receptacle 142. The retaining features 148 may flex or compress to allow the hanger 10 to be inserted into and removed from the socket 140 by a “snapping” action. While the retaining features 148 of the illustrated example are integrally formed with the opposing side surfaces 144, the retaining features 148 may be fixed to coupler 120, such as via adhesive or other fastening means. For example, the retaining features 148 may be compressible, rubber protrusions fixed to the rigid material of the coupler 120.

A second receptacle 152 has a depth D₁₅₂ and extends from the bottom of the first receptacle 142 toward the bottom side 124 and extends through the thickness T₁₂₀ of the coupler 120. That is, opposing second receptacle side surfaces 154 extend from respective lower ends of the support surfaces 146 of the first receptacle 142 to define the second receptacle 152 having a width W₁₅₂ that is less than the width W₁₄₂ of the first receptacle 142. A bottom surface or trough 156 connects between the opposing side surfaces 154 at the bottom of the socket 140. Furthermore, second receptacle retaining features 158, which may be configured similarly to the first receptacle retaining features 148, are disposed along the opposing side surfaces 154 to capture the hanger 10 in the second receptacle 152 via a snap fit.

Thus, the second receptacle 152 is configured to accommodate a corresponding thickness or gauge of hanger 10 that is less than the gauge of hanger 10 accommodated by the first receptacle 142. When a hanger 10 having a thickness or width W₁₀ that is less than the width W₁₄₂ of the first receptacle 142 and less than or equal to the width W₁₅₂ of the second receptacle 152, the hanger 10 rests in the second receptacle 152 when supported by the coupler 120. Both the width W₁₄₂ of the first receptacle 142 and the width W₁₅₂ of the second receptacle 152 are less than the width W₁₂₀ of the coupler 120 so that the socket 140 is bounded on opposing sides by structure of the coupler 120.

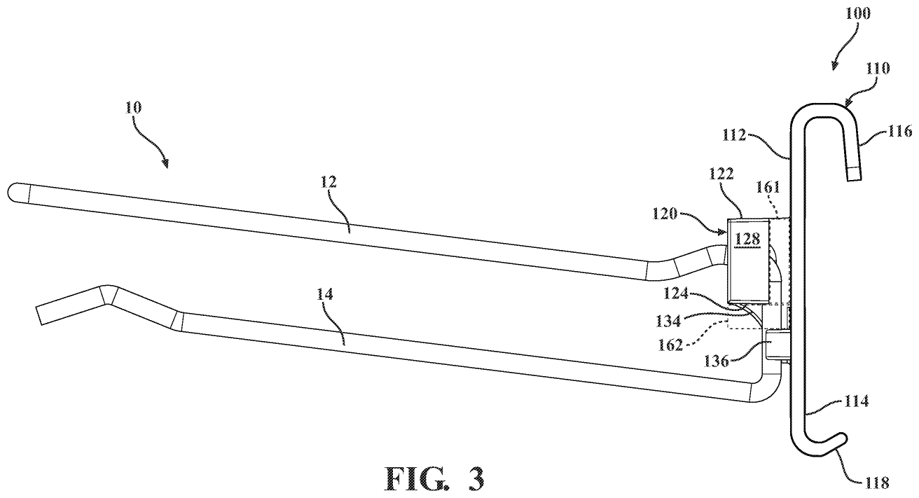

A series of channels or slots separate portions of the coupler 120 and the retainer 110 so that the hanger 10 may be guided along or through the channels when positioning the hanger 10 at the bracket 100 or removing the hanger 10 from the bracket 100. For example, and as shown in FIGS. 3 and 6, a vertical (i.e., parallel to the first surface 112) first channel or slot 161 separates the rear surface 123 of the coupler 120 and the retainer 110 along the second side 128 between the top side 122 and the bottom side 124. The first channel 161 extends from the second side 128 toward the first side 126 to provide a passage from the second side 128 and the socket 140. Thus, the first channel 161 extends from the second side 128 toward the first side 126 (and to at least the socket 140) and is defined by the front surface 112 of the retainer 110 and the rear surface 123 of the coupler 120.

As shown in FIGS. 3, 5, and 8, a longitudinally-extending (i.e., transverse to the front surface 112) second channel or slot 162 separates the bottom side 124 of the coupler 120 and an upper side 137 of the abutment 136 between the front surface 121 of the coupler 120 and the front surface 112 of the retainer 110. The second channel 162 extends from the second side 128 of the coupler 120 toward the first side 126 of the coupler 120 and at least to the gusset 134 of the first side 126. A height of the second channel 162 is defined between the bottom side 124 and an upper edge or surface of the abutment 136. The second channel 162 connects to the first channel 161.

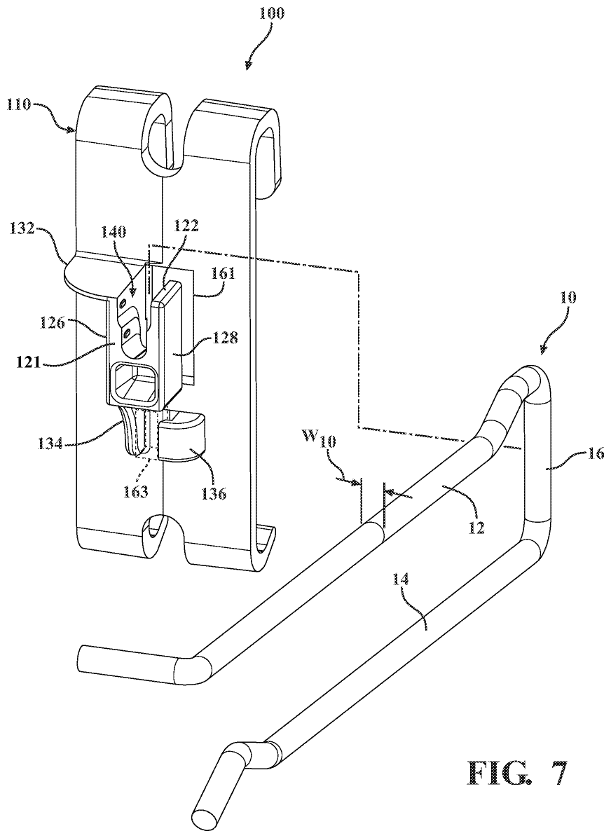

Furthermore, and as shown in FIGS. 5 and 7, a vertically-extending (i.e., parallel to the front surface 112) third channel or slot 163 is defined by and separates the gusset 134 of the first side 126 and the abutment 136 and extends from the bottom side 124 away from the coupler 120. The third channel 163 is axially aligned with the socket 140 to guide alignment of the lower arm 14 and the upper arm 12 when the hanger 10 is disposed in the socket 140.

Referring to FIG. 7, the hanger 10 is shown removed from the bracket 100, such as if the bracket 100 were disposed at the display unit and the hanger 10 were being positioned at the bracket 100. To position the hanger 10 at the bracket 100, a user must first move the hanger 10 so that the connecting arm 16 passes through the first channel 161 between the coupler 120 and the front surface 112 of the retainer 110 to align the upper arm 12 with the opening 141 of the socket 140. The second channel 162, which is connected to the first channel 161, allows the lower arm 14 of the hanger 10 to pass below the bottom side 124 of the coupler 120 as the connecting arm 16 passes through the first channel 161.

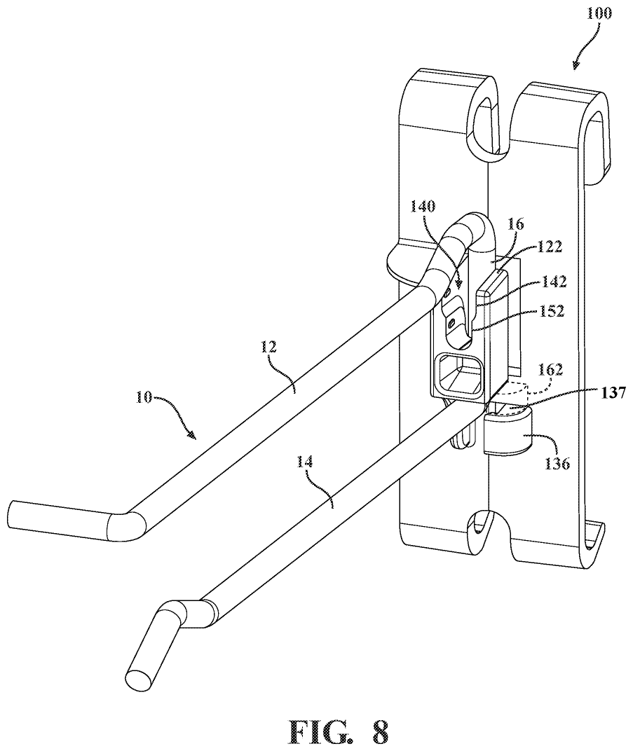

Thus, and as shown in FIG. 8, the upper arm 12 of the hanger 10 may be moved into alignment with the socket 140 by passing the substantially vertical connecting arm 16 through the first channel 161 and the substantially horizontal lower arm 14 through the second channel 162 until the upper arm 12 is positioned above and aligned with the socket 140. With the upper arm 12 positioned above the socket 140, the lower arm 14 is aligned with the upper arm 12 and positioned below the coupler 120 and within the third channel 163. As the connecting arm 16 passes through the first channel 161 and the lower arm 14 passes through the second channel 162, the upper arm 12 moves above and along the top side 122 of the coupler 120 and is aligned with the opening 141 of the socket 140.

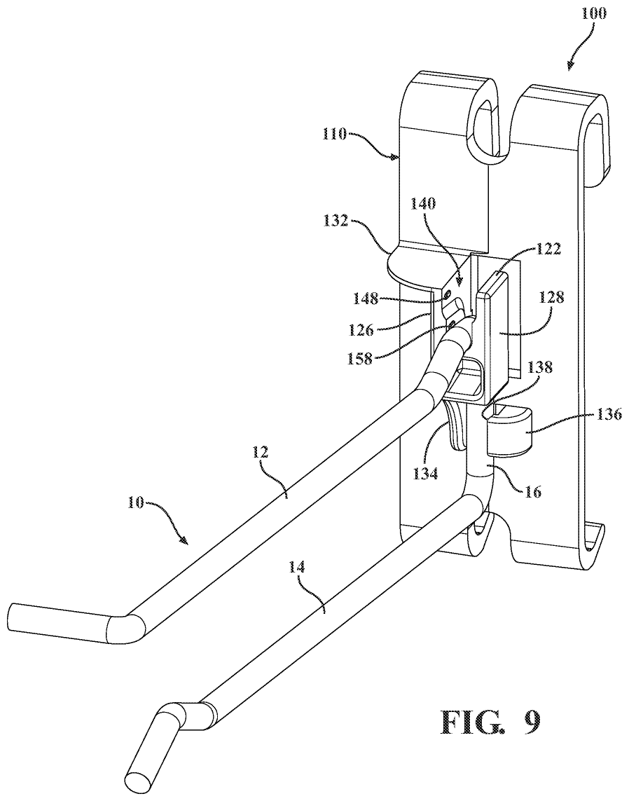

Turning to FIG. 9, with the upper arm 12 aligned with the opening 141 of the socket 140, the connecting arm 16 is axially aligned with the third channel 163. As the upper arm 12 is moved downward into the socket 140 to secure the hanger 10 at the bracket 100, the connecting arm 16 moves through the third channel 163 and between the gusset 134 and the abutment 136 to maintain alignment of the lower arm 14 and the upper arm 12. That is, if the hanger 10 pivots during installation, the connecting arm 16 or lower arm 14 engages the gusset 134 or the abutment 136 to counter the pivoting. With the hanger 10 in position, the lip 138 at the distal end of the abutment 136 may preclude the hanger 10 from pulling out of the coupler 120.

Thus, with the hanger 10 received at the coupler 120, the upper arm 12 extends along the socket 140 (and more specifically, along one of the first receptacle 142 or the second receptacle 152). In the illustrated example, the upper arm 12 extends along the thinner, second receptacle 152 and is retained therein by the protrusions 158 along the opposing side surfaces 154 of the second receptacle 152. If the hanger 10 had a width W₁₀ greater than the width W₁₅₂ of the second receptacle 152 (and less than or equal to the width W₁₄₂ of the first receptacle 142), the hanger 10 would instead be disposed along the first receptacle 142. With the hanger 10 received at the coupler 120, the lower arm 14 extends away from the front surface 112 of the retainer 110 and below the bottom side 124 of the coupler 120. With the hanger 10 received at the coupler 120, the connecting arm 16 extends along the first channel 161 between the coupler 120 and the front surface 112 of the retainer 110 and along the third channel 163 between the gusset 134 and the abutment 136.

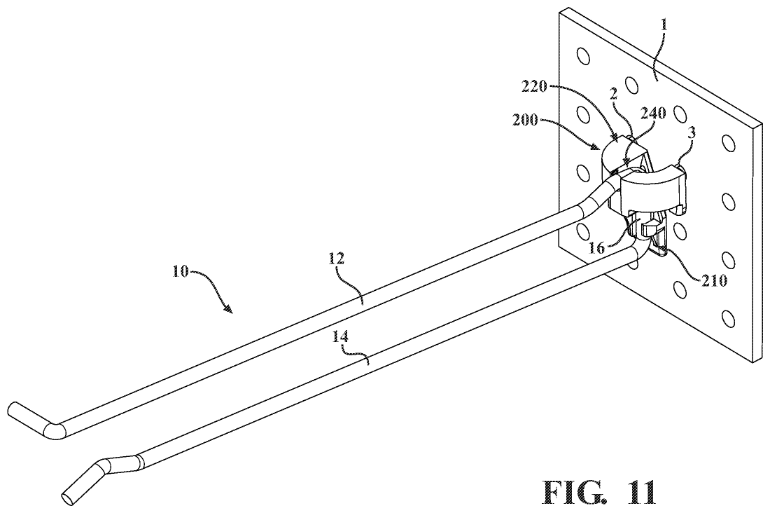

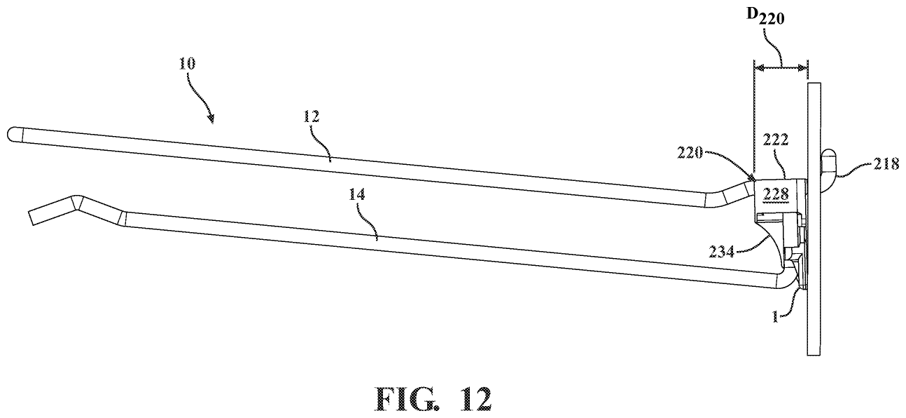

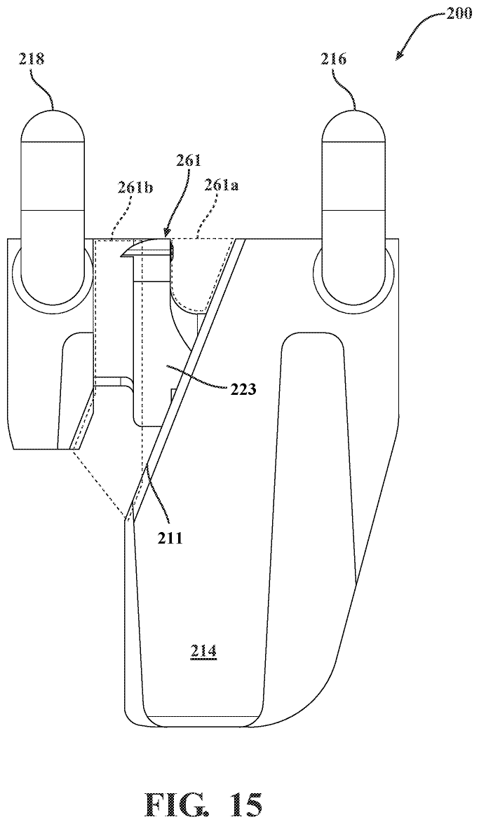

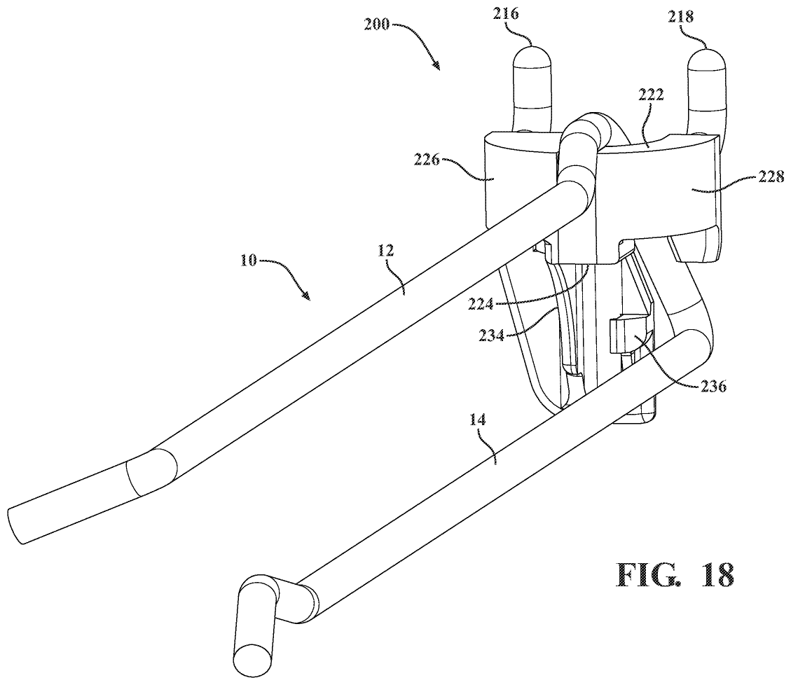

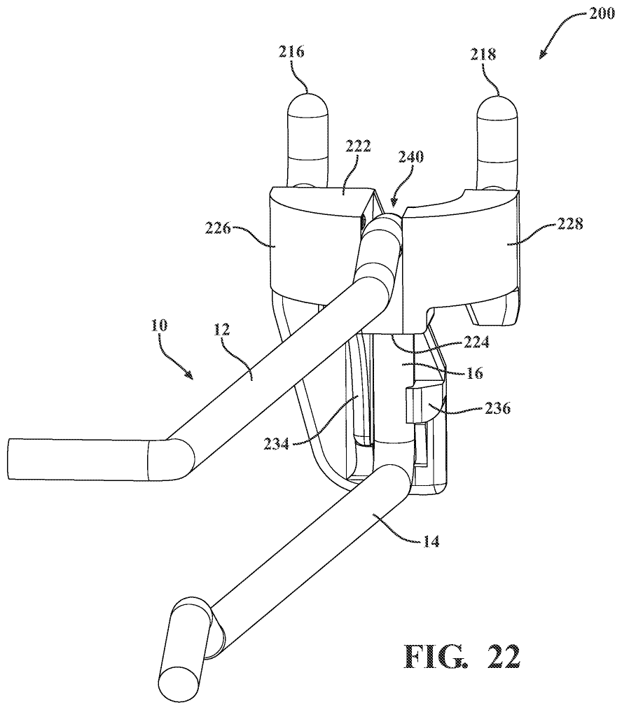

Referring to FIGS. 11-22, another example of a bracket 200 is shown that is configured to attach to support structure 1 of the display unit at both sides of the retainer 210 and that includes a coupler 220 that attaches at both sides to the retainer 210. That is, when the retainer 210 is received at the support structure 1, the hanger 10 is retained between the retainer 210 and the coupler 220 and cannot be removed through a channel along a side of the coupler 220, like described above with respect to the bracket 100. Thus, and as discussed further below, the hanger 10 is assembled to the bracket 200 prior to attachment to the support structure 1 and in an unsecured or loose state (e.g., FIG. 18), and once the bracket 200 is secured at the support structure 1, the hanger 10 is adjustable relative to the bracket 200 and coupler 220 between the unsecured state and a secured state (e.g., FIG. 22). This reduces the clearances surrounding the bracket 200 at the support structure 1 necessary to assemble and disassemble the hanger 10 at the coupler 220. Furthermore, supporting the coupler 220 at left and right sides provides additional structural support, such that weaker or less expensive materials may be used while achieving the same or better structural integrity for the hanger 10. For example, the bracket 200 may be formed from an acetal instead of glass-filled nylon used in traditional brackets. The bracket 200 may be configured to support the hanger 10 described herein or any other suitable wire hanger or peg hook.

The retainer 210 may include any suitable attachment means for positioning the bracket 200 at the display unit. For example, and as shown in FIGS. 11-16, the retainer 210 includes a rear surface 214 that engages the support structure 1 and a front surface 212 opposite the rear surface 214 and facing away from the support structure 1. The coupler 220 is attached to or coupled to or integrally formed with the front surface 212 of the retainer 210. A first retaining feature or hook 216 and a second retaining feature or hook 218 extend from the rear surface 214 so that, when the bracket 200 is disposed at the support structure 1, the first hook 216 passes through a first aperture 2 of the support structure 1 and the second hook 218 passes through a second aperture 3 of the support structure 1 to retain the bracket 200 at the support structure 1. That is, in the illustrated embodiment, the retainer 210 includes hooks configured to engage the peg board 1.

In the illustrated example, the coupler 220 is integrally formed with the retainer 210, and the coupler 220 is attached both at a first side 226 of the coupler 220 and at a second side 228 of the coupler 220. Optionally, the coupler 220 may be attached to the front surface 212 of the retainer 210, such as via adhesive or snap attachment or other fastening means. Alternatively, the coupler 220 may attach to an upper portion of the retainer 210 such that the coupler 220 extends over a top side of the retainer 210.

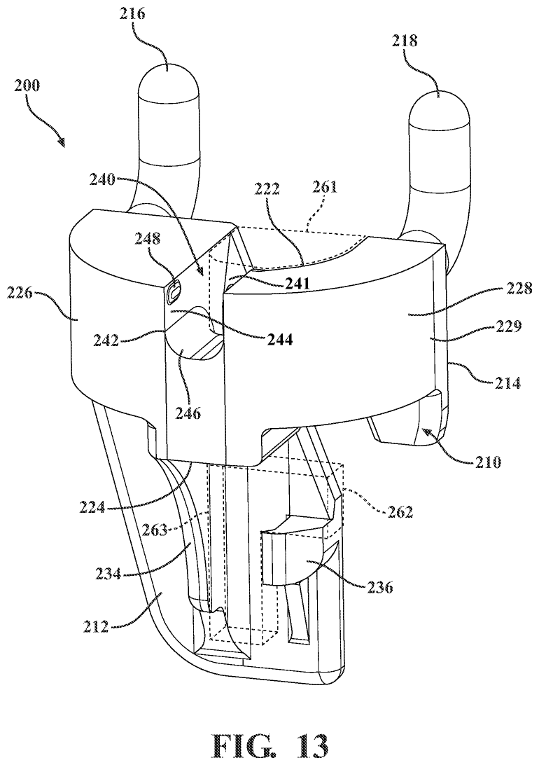

Referring to FIGS. 13-17G, the coupler 220 includes the first side 226 attached to or integrally formed with the front surface 212 of the retainer 210 and the second side 228 opposite the first side 226 is also attached to or integrally formed with the front surface 212 of the retainer 210. A distance from the first side 226 to the second side 228 defines a width W₂₂₀ of the coupler 220. The first side 226 and the second side 228 may have any suitable shape or configuration, such as the planar sides described above with respect to the bracket 100. In the illustrated embodiment, the first side 226 and the second side 228 provide curved or arcuate walls extending from the front surface 212 of the retainer 210 and curving toward one another at a distal end 221 of the coupler 220 to define a thickness T₂₂₀ of the coupler 220. That is, the thickness T₂₂₀ of the coupler 220 extends between the front surface 212 of the retainer 210 and a front-facing distal end 221 of the coupler 220 at an apex or meeting point of the two curved side surfaces 226, 228. While the sides 226, 228 of the present example are shown as arcuate, the sides 226, 228 may include different configurations in other examples. For example, the sides 226, 228 may have a straight or polygonal profile. In some examples, the side 226, 228 may include a pair of elbows each having two perpendicular arm portions extending between the retainer 210 and the socket 240.

The top side 222 of the coupler 220 extends between the first side 226 and the second side 228. The socket 240 extends from an opening 241 in the top side 222 and toward a bottom side 224 of the coupler 220 that is opposite the top side 222 and separated from the top side 222 by a height H₂₂₀ of the coupler 220. That is, the height H₂₂₀ of the coupler 220 extends from the top side 222 to the bottom side 224.

The distal end 221 of the coupler 220 extends between the top side 222 and the bottom side 224 and faces away from the front surface 212 of the retainer 210. In the illustrated example, the distal end 221 is formed continuously with the first side 226 and the second side 228 of the coupler 220 to provide the periphery of the coupler 220 with a constant and continuous radius of curvature. A rear surface 223 of the coupler 220 faces the front surface 212 of the retainer 210 and is spaced from the retainer 210 to allow for movement of the hanger 10 between the coupler 220 and the retainer 210 and/or support structure 1 of the display unit.

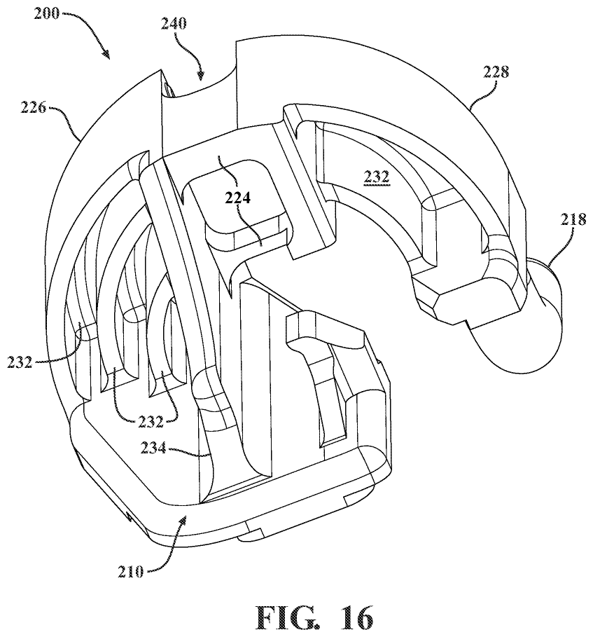

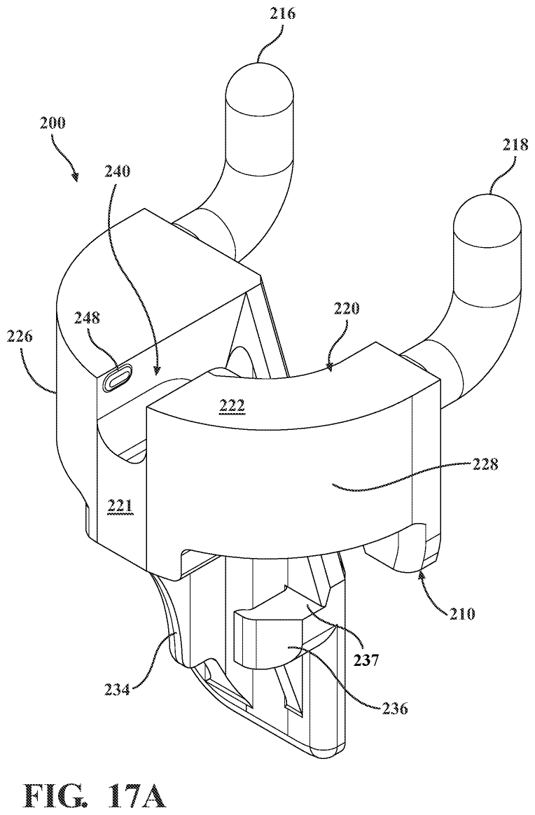

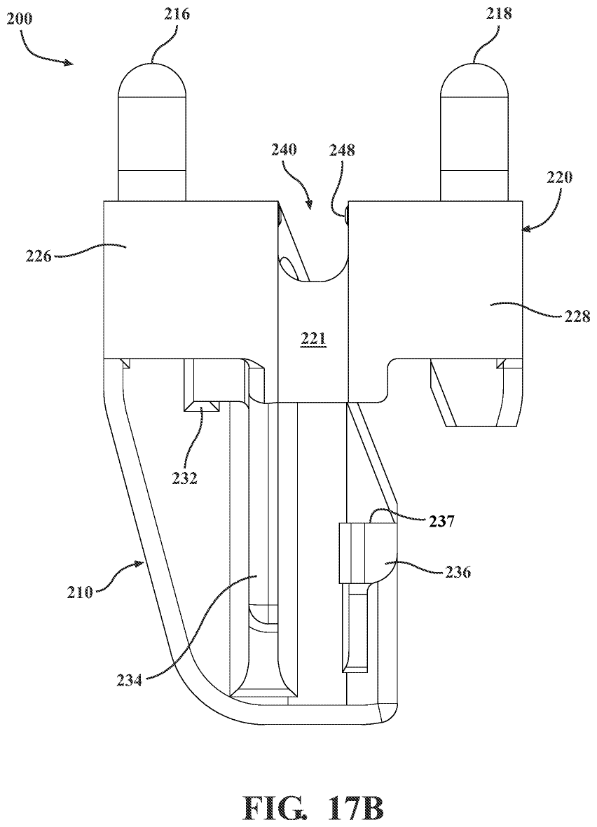

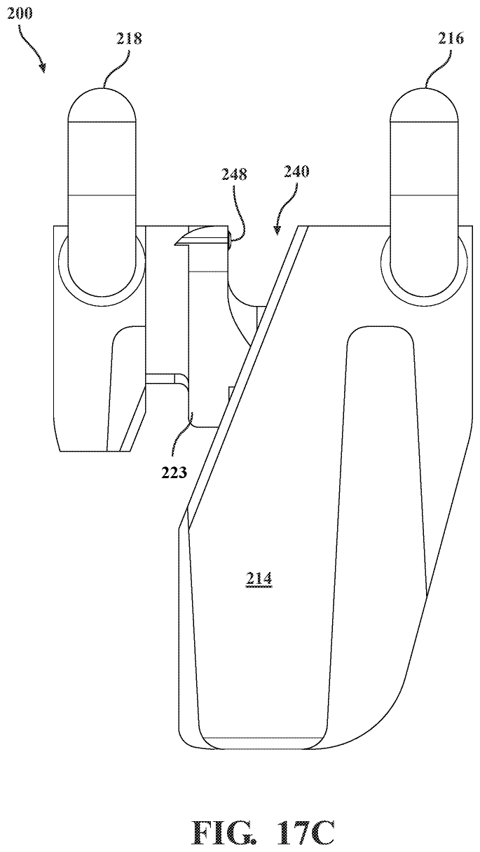

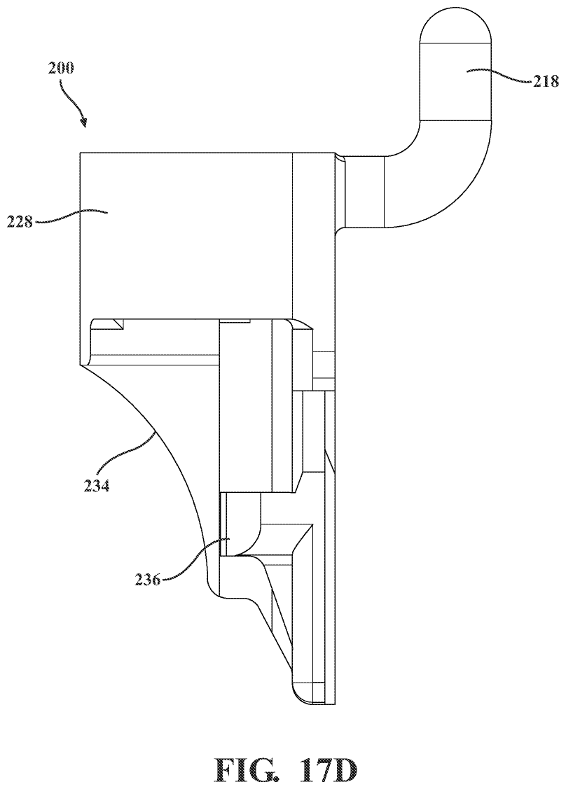

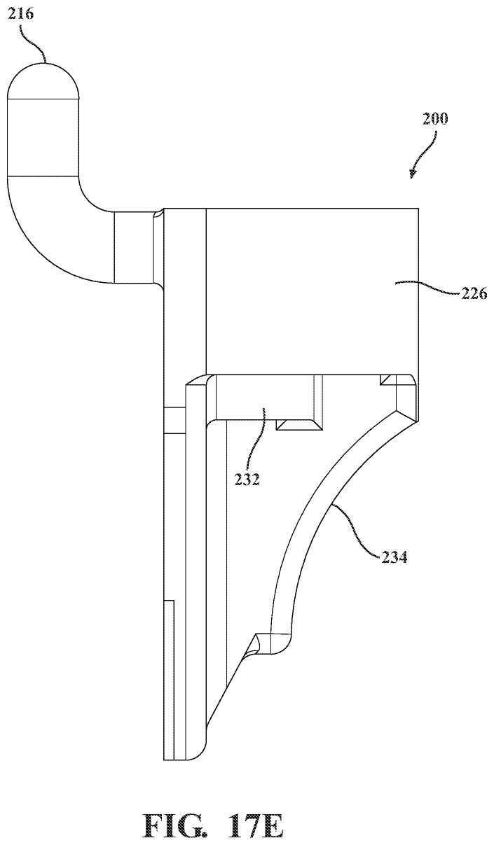

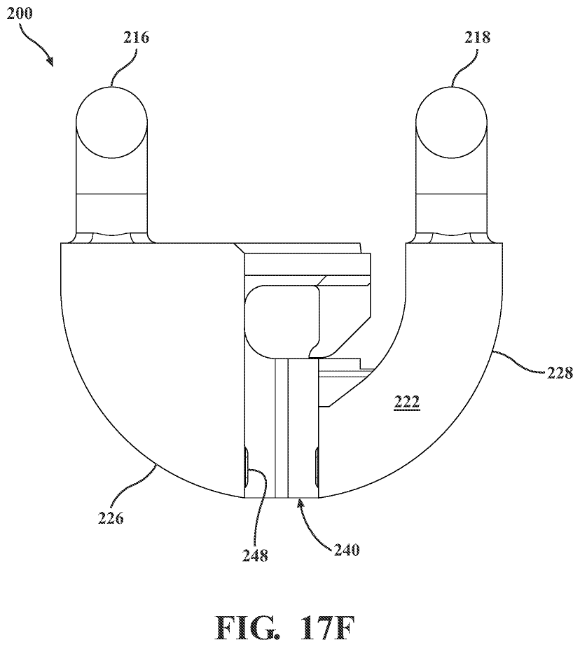

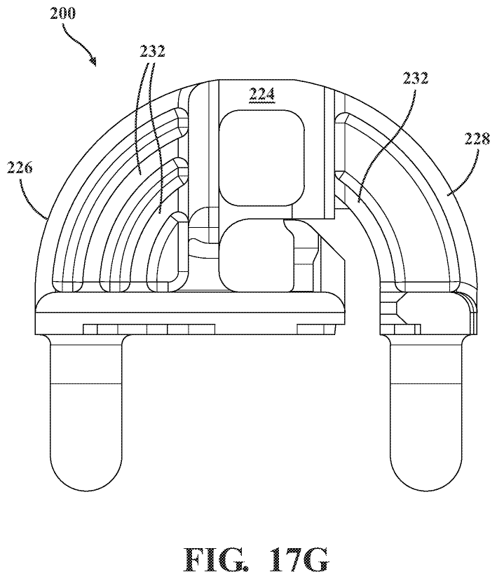

The first side 226 of the coupler 220 includes a connecting portion 230 that attaches the coupler 220 at the front surface 212 of the retainer 210. As best shown in FIGS. 16 and 17G, the connecting portion 230 includes a plurality of curved or arcuate connecting ribs 232 connecting between the front surface 212 and the coupler 220 to prevent deflection or deformation of the coupler 220 when under load from the hanger 10 and items at the hanger 10. A lower portion or gusset 234 of the first side 226 may extend below the bottom side 224 of the coupler 220 to further support the coupler 220 and partially define a guide channel for the hanger 10.

The second side 228 also includes a connecting portion 229 that attaches the coupler 220 at the front surface 212 of the retainer 210. The connecting portion 229 may also include one or more curved or arcuate connecting ribs 232 connecting between the front surface 212 and the coupler 220. Thus, the coupler 220 is connected to the retainer 210 along both sides of the coupler 220 to improve strength of the bracket 200 and retain the hanger 10 between the coupler 220 and retainer 210 while installing the bracket 200 at the display unit.

A wall or abutment 236 of the coupler 220 is spaced from the gusset 234 of the first side 226 so that, when the hanger 10 is positioned at the coupler 220 in the secured state, the connecting arm 16 extends between the gusset 234 of the first side 226 and the abutment 236 to align the upper arm 12 and the lower arm 14 vertically relative to one another. Furthermore, the abutment 236 is spaced from the bottom side 224 of the coupler 220 on the second side 228 so that, when the hanger 10 is adjusted from the unsecured state toward the secured state, a portion of the hanger 10 (e.g., the lower arm 14 and connecting arm 16) may pass between an upper side 237 of the abutment 236 and the bottom side 224 and second side 228 of the coupler 220. The abutment 236 may include a protrusion or lip 238 at a distal end opposite the front surface 212 of the retainer 210 to prevent the hanger 10 from pulling out from the coupler 220 when disposed at the bracket 200.

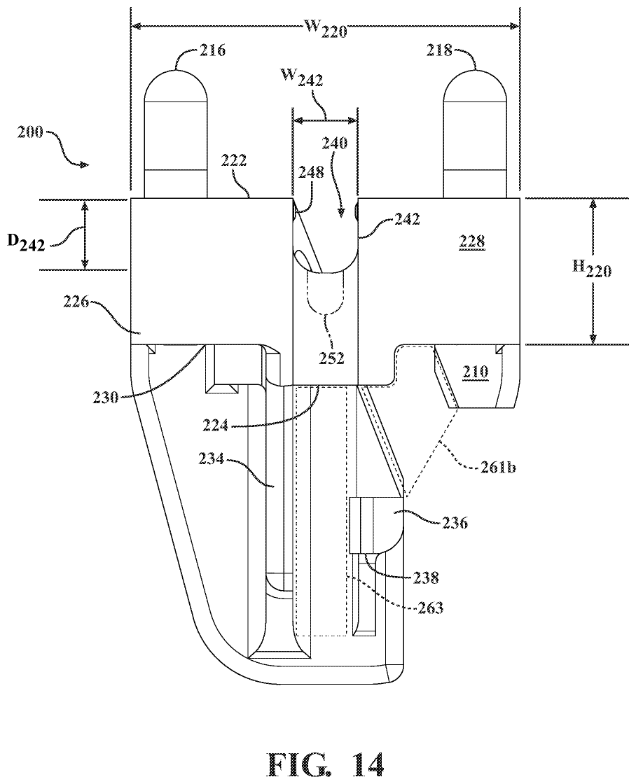

As shown in FIG. 14, the socket 240 extends from the top side 222 of the coupler 220 and is configured to receive the hanger 10. Similar to the socket 140 of the bracket 100, the socket 240 includes a channel or receptacle 242 having a depth D₂₄₂ and that extends from the opening 241 in the top side 222 of the coupler 220 and toward the bottom side 224 along the thickness T₂₂₀ of the coupler 220. The receptacle 242 is defined by opposing side surfaces 244 that face one another and are spaced by a width W₂₄₂ of the receptacle 242. A bottom support surface or trough 246 connects between the opposing side surfaces 244 at the bottom of the socket 240 and, when disposed in the socket 240, the hanger 10 rests along the support surface 246. Respective retaining features 248, such as nubs or protrusions or bumpers, extend from the opposing side surfaces 244 to retain the hanger 10 within the socket 240. Although shown as including only a single receptacle 242, the coupler 220 may include a second, thinner receptacle 252 similar to the second receptacle 152 described herein.

A series of channels or slots separate portions of the coupler 220 and the retainer 210 so that the hanger 10 may be adjusted from the loose or unsecured position toward the secured position after the bracket 200 is disposed at the display unit. For example, and as shown in FIGS. 13-15 and 19-21, a first channel or slot 261 is formed through the rear of the bracket 200 at a position between the second side 228 and the first side 226 and between the top side 222 and the bottom side 224. Thus, the first channel 261 connects the socket 240 and a space or gap adjacent the socket 240 and toward the second side 228 so that the hanger 10 may be moved from the space adjacent the socket 240 into alignment with the socket 240. The first channel 261 includes a first portion 261a axially aligned with the socket 240 and that extends from the rear surface 223 of the coupler and the retainer 210 and from the top side 222 to the bottom side 224. An edge of the first side 226 at the socket 240 defines an edge of the first portion 261a of the first channel 261. A second portion 261b of the first channel 261 is offset from the first portion 261a towards the second side 228 and may extend at an oblique angle or diagonal relative to the first portion 261a. The second portion 261b connects to the first portion 261a and is adjacent to the first portion 261a and socket 240 so that, when the hanger 10 is in the unsecured state and positioned within the first channel 261, the hanger 10 may move laterally from the first portion 261a to the second portion 261b relative to the socket 240. An opening 211 may be formed through the front surface 212 and rear surface 214 of the retainer 210 that connects to the first channel 261 so that the hanger 10 may be positioned into the first channel 261 through the opening 211 before positioning the bracket 200 at the display unit. The opening 211 may extend from the top side 222 to a lower edge of the retainer 210 to separate the retainer 210 between the first side 226 and second side 228 of the coupler 220. Thus, the hanger 10 may be inserted into the first channel 261 through the opening 211 at the rear surface 214 of the retainer 210.

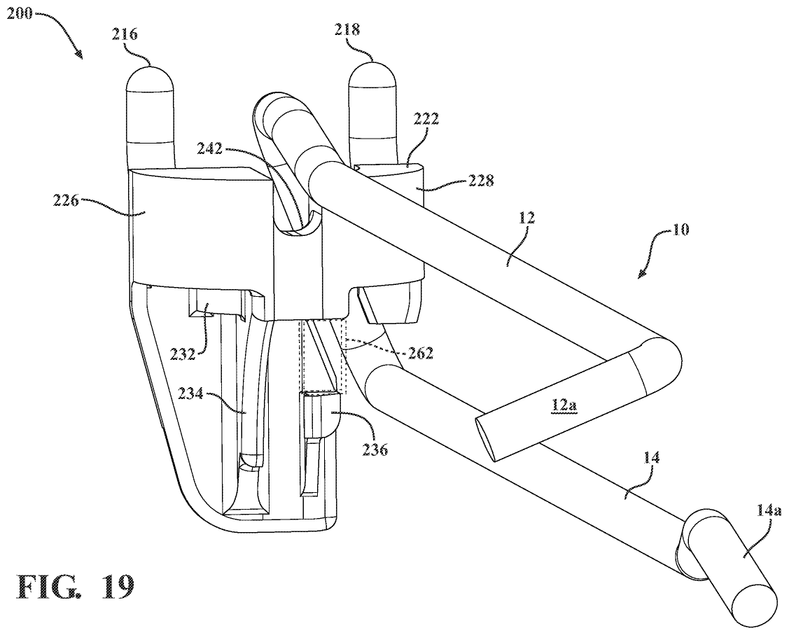

As shown in FIGS. 13 and 19, a second channel or slot 262 separates the bottom side 224 of the coupler 220 and the upper side 237 of the abutment 236 between the distal end 221 of the coupler 220 and the front surface 212 of the retainer 210. The second channel 262 extends from the second side 228 toward the first side 226 and at least to the gusset 234 of the first side 226. The second channel 262 is defined by the upper edge or side 237 of the abutment 236 and the bottom side 224 of the coupler 220. The second channel 262 connects the first portion 261a and the second portion 261b of the first channel 261.

Referring to FIGS. 13, 14, and 20, a third channel or slot 263 is defined by and separates the gusset 234 of the first side 226 of the coupler 220 and the abutment 236 and extends from the bottom side 224 away from the coupler 220. The third channel 263 is axially aligned with the socket 240 to guide alignment of the lower arm 14 with the upper arm 12 when the hanger 10 is disposed in the socket 240.

As shown in FIG. 18, the hanger 10 is in the loose or unsecured state, where the upper arm 12 is not disposed in the socket 240 and instead extends along and above the top side 222 at a position between the first side 226 and the second side 228. In the unsecured state, the connecting arm 16 extends along the diagonal second portion 261b of the first channel 261 to position the lower arm 14 along an outer side of the abutment 236 that is opposite the side of the abutment 236 defining the third channel 263 (i.e., outboard of the abutment 236 relative to the third channel 263). Thus, in the unsecured state, the hanger 10 is positioned offset relative to the socket 240 and third channel 263 so that the hanger 10 is free to move as the bracket 200 is positioned at the display unit. The hanger 10 rests or hangs from the top side 222 of the coupler 220 so that a user may grasp and manipulate the bracket 200 during installation without the need to also hold or position the hanger 10 relative to the bracket 200.

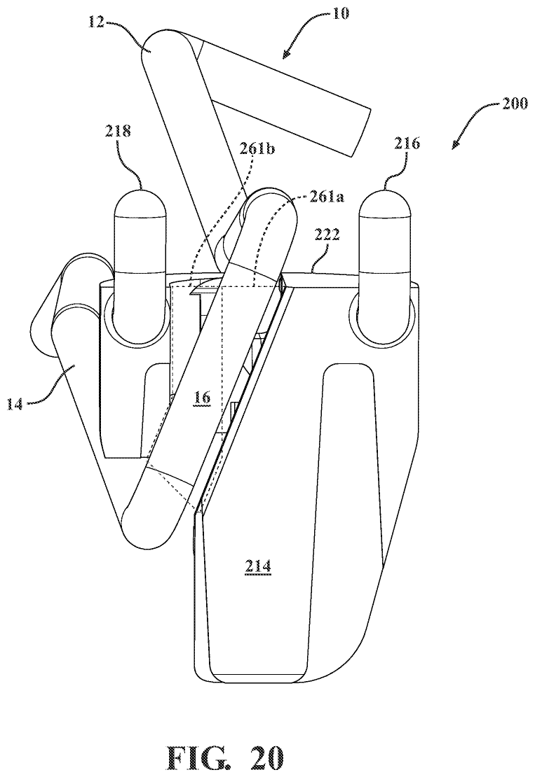

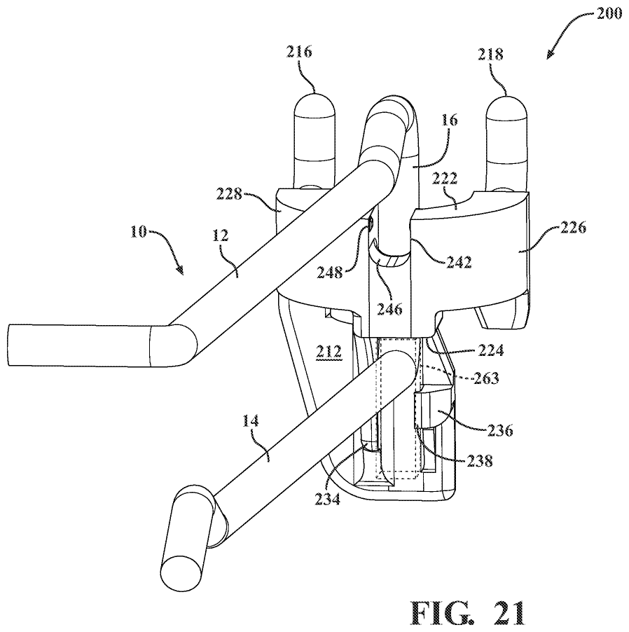

Once the bracket 200 is disposed at the display unit, the user may reposition or adjust or move the hanger 10 from the unsecured state (e.g., FIG. 18) toward the secured state (e.g., FIG. 22). To move the hanger 10 toward the secured state, the lower arm 14 must be moved through the second channel 262 to align the upper arm 12 with the socket 240 and position the connecting arm 16 and lower arm 14 along the third channel 263. As shown in FIGS. 19 and 20, the hanger 10 is moved along the diagonal second portion 261b of the first channel 261 to raise the lower arm 14 into alignment with the second channel 262. With the lower arm 14 aligned with the second channel 262, the hanger 10 is pivoted to pass the lower arm 14 along the second channel 262 while the connecting arm 16 moves through the second portion 261b of the first channel 261 toward the first portion 261a. While the lower arm 14 is moved along the second channel 262 and the connecting arm 16 moves along the first channel 261, the upper arm 12 is positioned above the top side 222 and aligns with the opening 241 of the socket 240. With the upper arm 12 aligned with the opening 241 of the socket 240 and the connecting arm 16 and lower arm 14 positioned along the third channel 263, such as shown in FIG. 21, the connecting arm 16 is axially aligned with the third channel 263. As the upper arm 12 is moved into the socket 240 to secure the hanger 10 at the bracket 200, the connecting arm 16 moves along the third channel 263 and between the gusset 234 and the abutment 236 to maintain alignment of the lower arm 14 and upper arm 12. With the hanger 10 in the secured position (i.e., with the upper arm 12 supported in the socket 240), such as shown in FIG. 22, the lip 238 at the abutment 236 precludes the hanger 10 from pulling out of the coupler 220.

Thus, when the hanger 10 is in the secured state relative to the coupler 220, the upper arm 12 extends along the socket 240 (such as along the receptacle 242) and is retained therein by the retaining features 248 along the opposing side surfaces 244 of the receptacle 242. With the hanger 10 received at the coupler 220 in the secured state, the lower arm 14 extends away from the front surface 212 of the retainer 210 and below the bottom side 224 of the coupler 220. Moreover, with the hanger 10 received at the coupler 220 in the secured state, the connecting arm 16 extends along the first portion 261a of the first channel 261 between the coupler 220 and the retainer 210 and along the third channel 263 between the gusset 234 of the first side 226 and the abutment 236. Furthermore, as the hanger 10 is adjusted between the unsecured state and the secured state, the hanger 10 remains within the footprint of the bracket 200, thereby reducing the space surrounding the bracket necessary for installation and deconstruction of the bracket 200 and hanger 10.

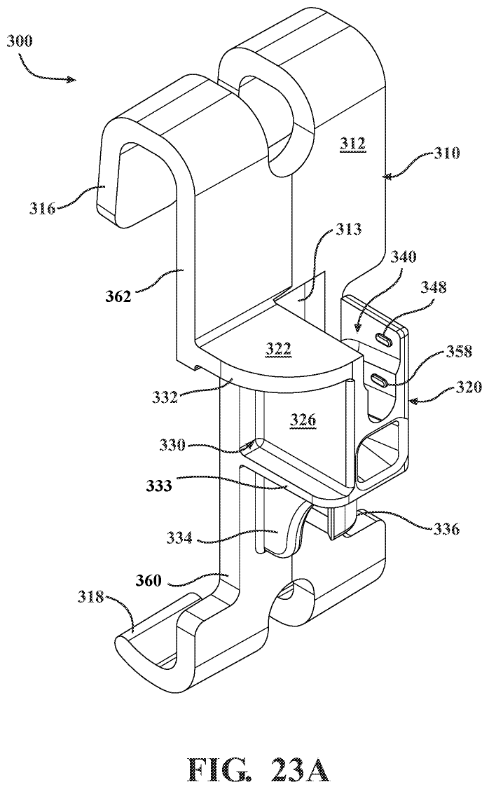

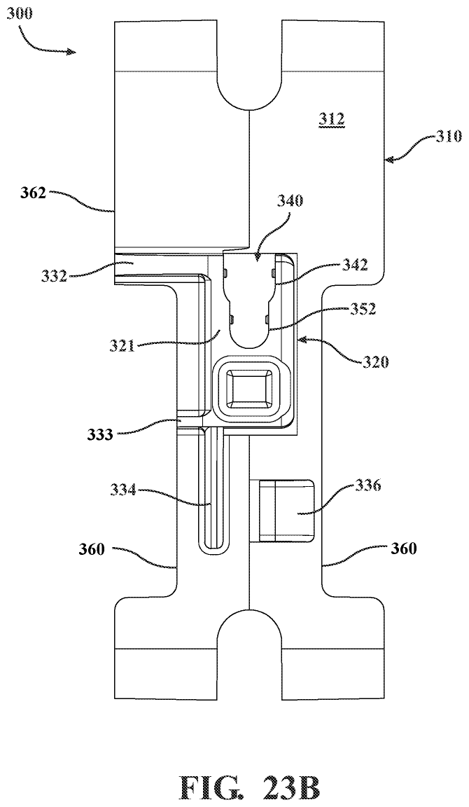

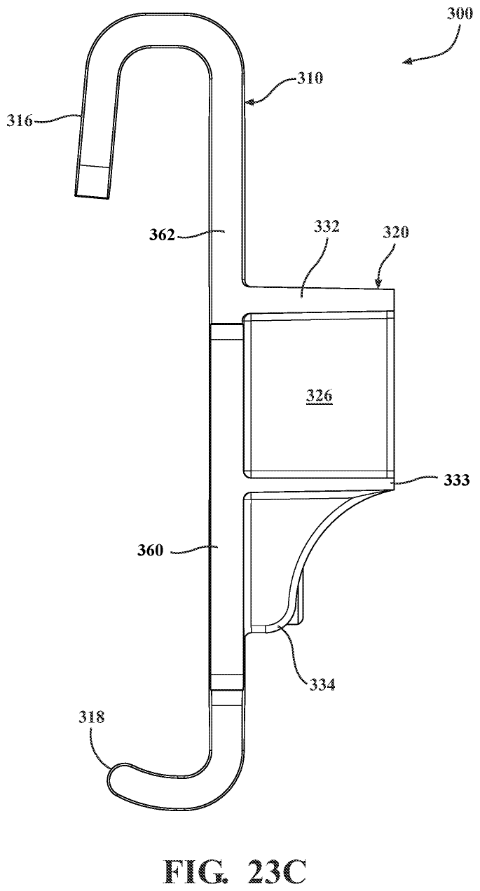

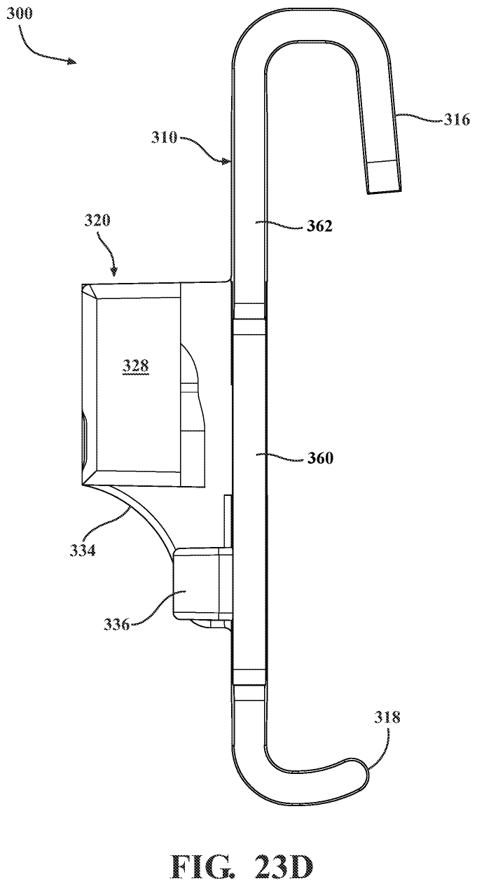

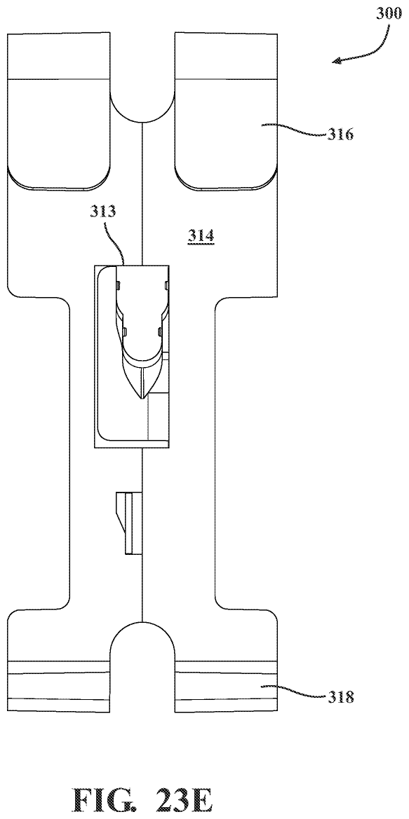

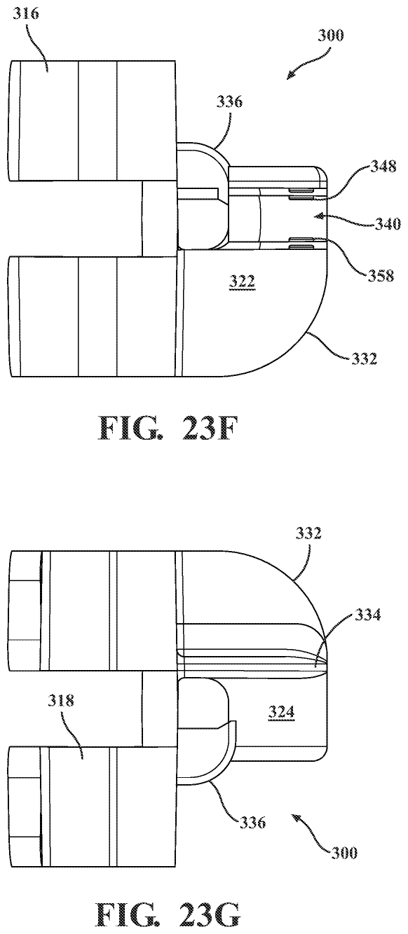

Referring to FIGS. 23A-23G, a bracket 300 configured to support the hanger 10 at the display unit includes a retainer 310 and a coupler 320 at a front surface 312 of the retainer 310. When the retainer 310 is positioned at the display unit like a wire grid wall, a first or upper retaining feature or hook 316 of the retainer 310 receives or wraps around a first, higher horizontal wire or rod and a second or lower retaining feature or hook 318 of the retainer 310 receives or wraps around a second, lower horizontal wire or rod. The upper retaining feature 316 and the lower retaining feature 318 may extend from or away from a rear surface 314 of the retainer 310, with the coupler 320 disposed along the front surface 312 of the retainer 310 between the upper retaining feature 316 and the lower retaining feature 318.

The coupler 320 includes a socket 340 that is configured to support the peg hook or hanger 10 at the display unit. For example, the coupler 320 includes a first channel or receptacle 342 that extends from a top side 322 of the coupler 320, and a second channel or receptacle 352 that extends from the first channel 342 toward a bottom side 324 of the coupler 320. In the illustrated example, the second channel 352 is narrower than the first channel 342 so that a hanger 10 having a greater thickness or gauge is supported within the first channel 342 and a hanger 10 having a lesser thickness or gauge is supported within the second channel 352. Further, first retaining features 348 are disposed along the first channel 342 and second retaining features 358 are disposed along the second channel 352 to engage the hanger 10 when the hanger 10 is disposed in the respective first channel 342 or second channel 352. The first retaining features 348 or second retaining features 358 flex or compress between the hanger 10 and the respective first channel 342 or second channel 352 to retain the hanger 10 within the socket 340 of the coupler 320.

Moreover, the coupler 320 is configured to allow for selective removal and installation of the hanger at the socket 340. For example, a series of channels or slots separate portions of the coupler 320 and the retainer 310 so that the hanger 10 may be guided along or through the channels when positioning the hanger 10 at the bracket 300. The coupler 320 is attached to or integrally formed with the retainer 310 along a first side 326 of the coupler 320, while a second side 328 opposite the first side 326 is spaced from or separated from the front surface 312 of the retainer 310 to allow the hanger 10 to be moved in and out of alignment with the socket 340. An indentation or passage or recess 313 is formed at least partially through the front surface 312 of the retainer 310 and behind the coupler 320, such as to provide clearance for the hanger 10 during installation and removal of the hanger 10.

The first side 326 of the coupler 320 includes a connecting portion 330 that extends along the first side 326 and that connects the coupler 320 to the front surface 312 of the retainer 310. In the illustrated example, the connecting portion 330 includes a first connecting rib or fin 332 extending between the first side 326 of the coupler 320 and the front surface 312 of the retainer 310. The first connecting rib 332 extends along an upper edge of the first side 326 between a front surface 321 of the coupler 320 and the front surface 312 of the retainer 310. Further, a second connecting rib 333 extends between the first side 326 of the coupler 320 and the front surface 312 of the retainer 310 along a lower edge of the first side 326, and the connecting portion 330 may include any number of connecting ribs along the first side 326 to provide added stability and support for the hanger 10 at the coupler 320. A gusset 334 of the first side 326 extends below the bottom side 324 of the coupler 320 and is attached at the retainer 310 to support the coupler 320. Additionally, a lower wall or abutment 336 extends from the retainer 310 below the coupler 320 and is spaced from the gusset 334 to provide lateral support to the hanger 10 disposed at the coupler 320.

Respective lateral recesses or notches or cutout regions 360 are formed at corresponding positions along the outer lateral edges 362 of the retainer 310 such that the retainer 310 is narrowed at the positions corresponding to the cutout regions 360. In the illustrated example, the cutout regions 360 extend along the retainer 310 between the lower retaining feature 318 and the first connecting rib 332 of the coupler 320. Thus, the first connecting rib 332 extends laterally from the coupler 320 and to the outer lateral edge 362 of the retainer 310, with the cutout region 360 extending toward the coupler 320 below the first connecting rib 332 and away from the first connecting rib 332 along the coupler 320 and toward the lower retaining feature 318. The second connecting rib 333 extends laterally from the coupler 320 and to the lateral edge of the retainer 310 at the cutout region 360. Thus, the cutout regions 360 reduce the footprint of the retainer 310, such as to reduce weight and materials cost of the bracket 300 and provide clearance for installation of the bracket 300 at the display unit.

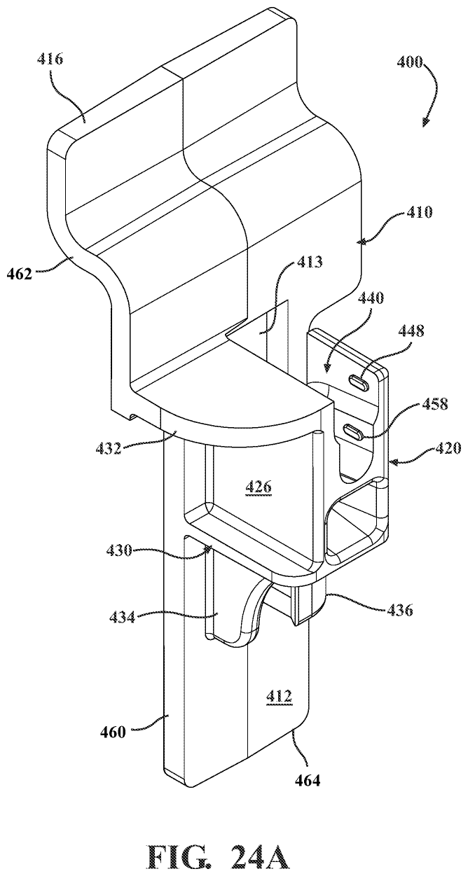

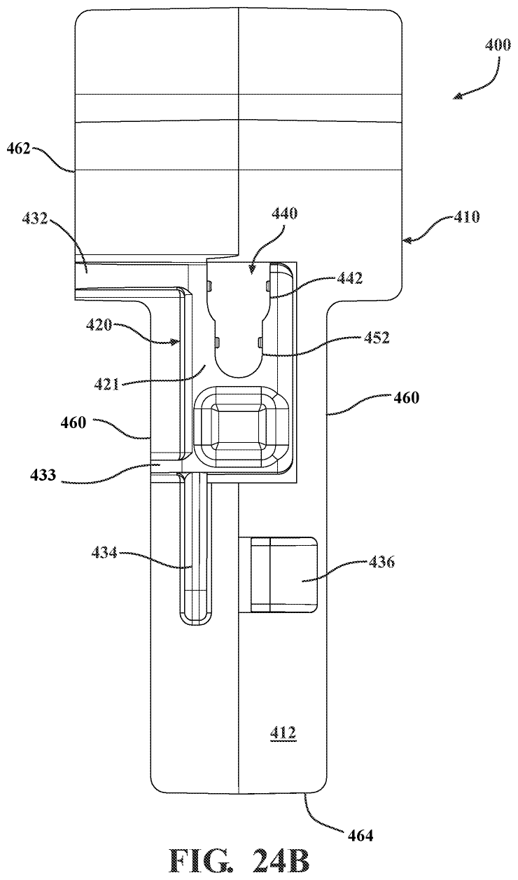

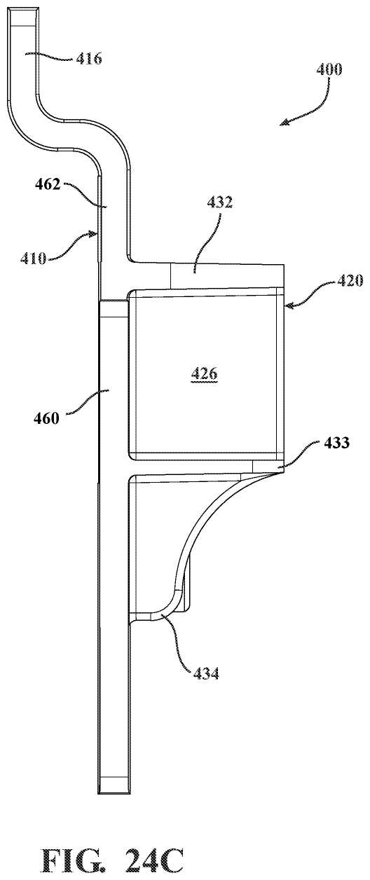

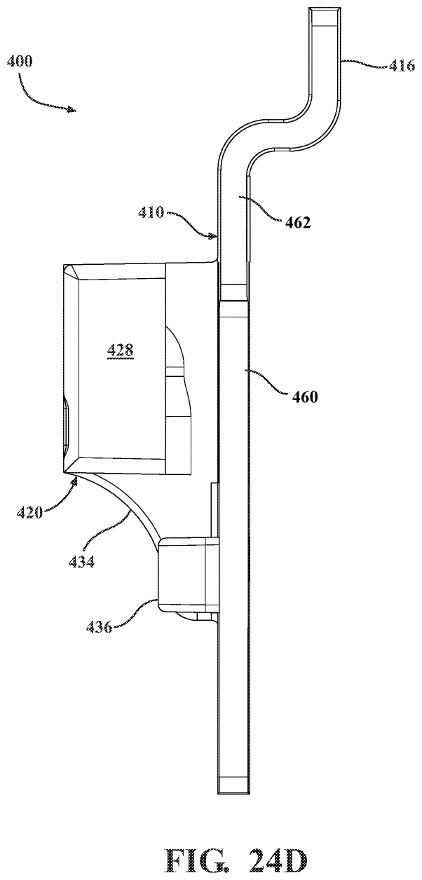

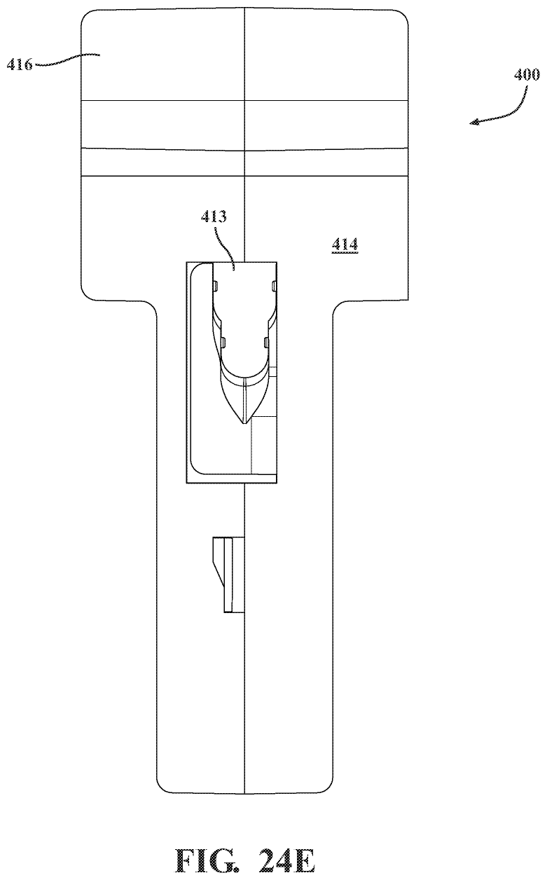

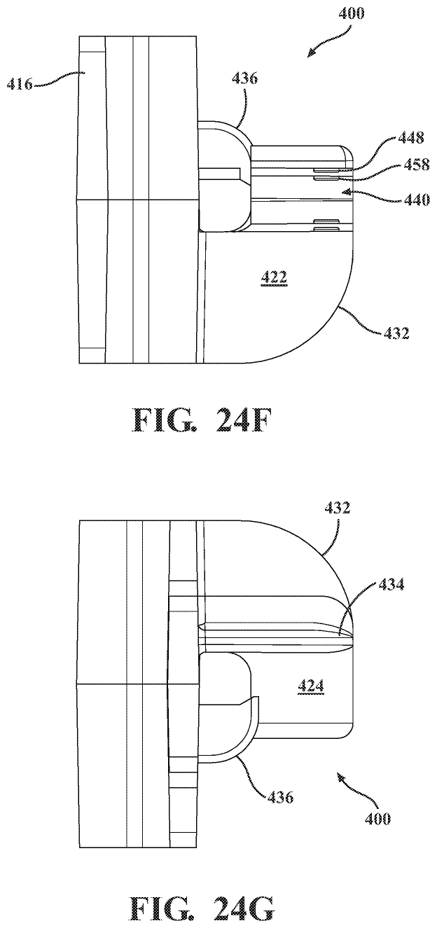

Referring to FIGS. 24A-24G, a bracket 400 configured to support the hanger 10 at the display unit includes a retainer 410 and a coupler 420 at a front surface 412 of the retainer 410. When the retainer 410 is positioned at a display unit like a slat wall panel, an upper retaining feature or slat wall hook or flange 416 of the retainer 410 is at least partially inserted into a corresponding slot or recess of the slat wall panel and the retaining feature 416 wraps around or extends behind a slat or surface of the slat wall panel to retain the bracket 400 at the slat wall panel. The weight of the bracket 400 urges the retaining feature 416 into engagement with the rear surface of the slat wall panel and urges a rear surface 414 of the retainer 410 into engagement with a front surface of the slat wall panel to secure the bracket 400 at the display unit. The coupler 420 is disposed along the front surface 412 of the retainer 410 below the upper retaining feature 416. Optionally, a lower retaining feature extends from a lower portion of the retainer 410 for engaging a lower slot or recess of the slat wall panel.

The coupler 420 includes a socket 440 that is configured to support the peg hook or hanger 10 at the display unit. For example, the coupler 420 includes a first channel or receptacle 442 that extends from a top side 422 of the coupler 420, and a second channel or receptacle 452 that extends from the first channel 442 toward a bottom side 424 of the coupler 420. In the illustrated example, the second channel 452 is narrower than the first channel 442 so that a hanger 10 having a greater thickness or gauge is supported within the first channel 442 and a hanger 10 having a lesser thickness or gauge is supported within the second channel 452. Further, first retaining features 448 are disposed along the first channel 442 and second retaining features 458 are disposed along the second channel 452 to engage the hanger 10 when the hanger 10 is disposed in the respective first channel 442 or second channel 452. The first retaining features 448 or second retaining features 458 flex or compress between the hanger 10 and the respective first channel 442 or second channel 452 to retain the hanger 10 within the socket 440 of the coupler 420.

Moreover, the coupler 420 is configured to allow for selective removal and installation of the hanger at the socket 440. For example, a series of channels or slots separate portions of the coupler 420 and the retainer 410 so that the hanger 10 may be guided along or through the channels when positioning the hanger 10 at the bracket 400. The coupler 420 is attached to or integrally formed with the retainer 410 along a first side 426 of the coupler 420, while a second side 428 opposite the first side 426 is spaced from or separated from the front surface 412 of the retainer 410 to allow the hanger 10 to be moved in and out of alignment with the socket 440. An indentation or passage or recess 413 is formed at least partially through the front surface 412 of the retainer 410 and behind the coupler 420, such as to provide clearance for the hanger 10 during installation and removal of the hanger 10.

The first side 426 of the coupler 420 includes a connecting portion 430 that extends along the first side 426 and that connects the coupler 420 to the front surface 412 of the retainer 410. In the illustrated example, the connecting portion 430 includes a first connecting rib or fin 432 extending between the first side 426 of the coupler 420 and the front surface 412 of the retainer 410. The first connecting rib 432 extends along an upper edge of the first side 426 between a front surface 421 of the coupler 420 and the front surface 412 of the retainer 410. Further, a second connecting rib 433 extends between the first side 426 of the coupler 420 and the front surface 412 of the retainer 410 along a lower edge of the first side 426, and the connecting portion 430 may include any number of connecting ribs along the first side 426 to provide added stability and support for the hanger 10 at the coupler 420. A gusset 434 of the first side 426 extends below the bottom side 424 of the coupler 420 and is attached at the retainer 410 to support the coupler 420. Additionally, a lower wall or abutment 436 extends from the retainer 410 below the coupler 420 and is spaced from the gusset 434 to provide lateral support to the hanger 10 disposed at the coupler 420.

Respective lateral recesses or notches or cutout regions 460 are formed at corresponding positions along the outer lateral edges 462 of the retainer 410 such that the retainer 410 is narrowed at the positions corresponding to the cutout regions 460. In the illustrated example, the cutout regions 460 extend along the retainer 410 and from the first connecting rib 432 of the coupler 420. Thus, the first connecting rib 432 extends laterally from the coupler 420 and to the outer lateral edge 462 of the retainer 410, with the cutout region 460 extending toward the coupler 420 below the first connecting rib 432 and away from the first connecting rib 432 along the coupler 420. The cutout regions 460 may extend between a lower edge 464 of the retainer 410 and the first connecting rib 432. The second connecting rib 433 extends laterally from the coupler 420 and to the lateral edge of the retainer 410 at the cutout region 460. Thus, the cutout regions 460 reduce the footprint of the retainer 410, such as to reduce weight and materials cost of the bracket 400 and provide clearance for installation of the bracket 400 at the display unit.

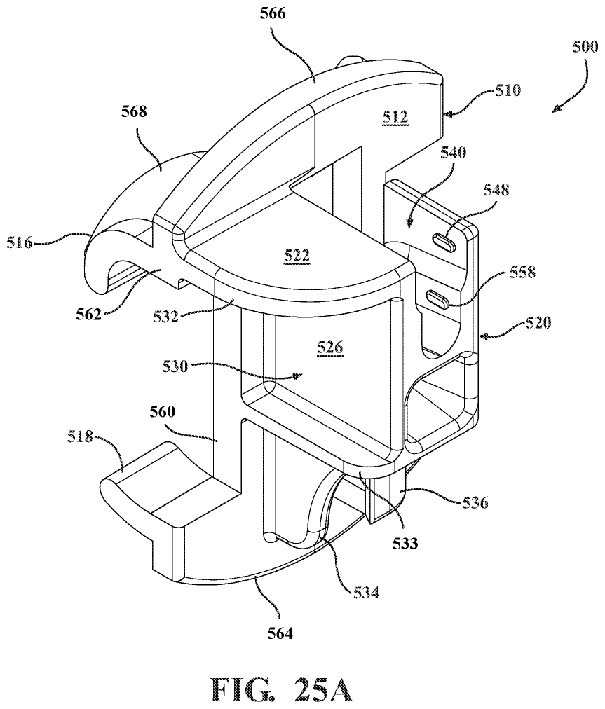

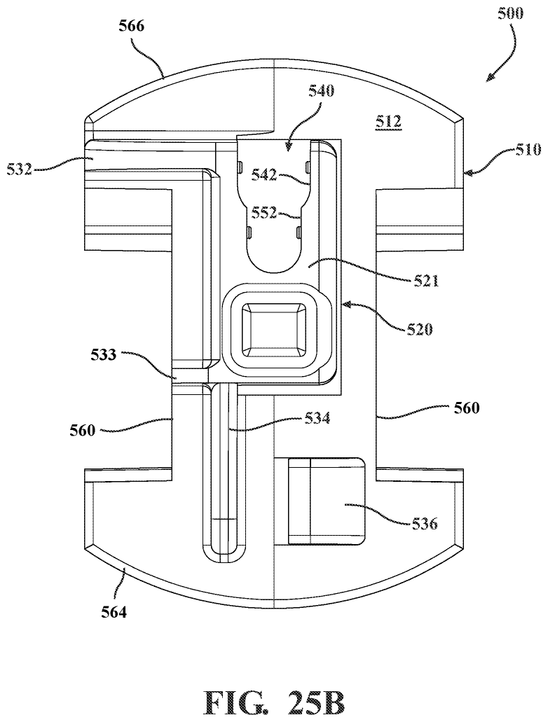

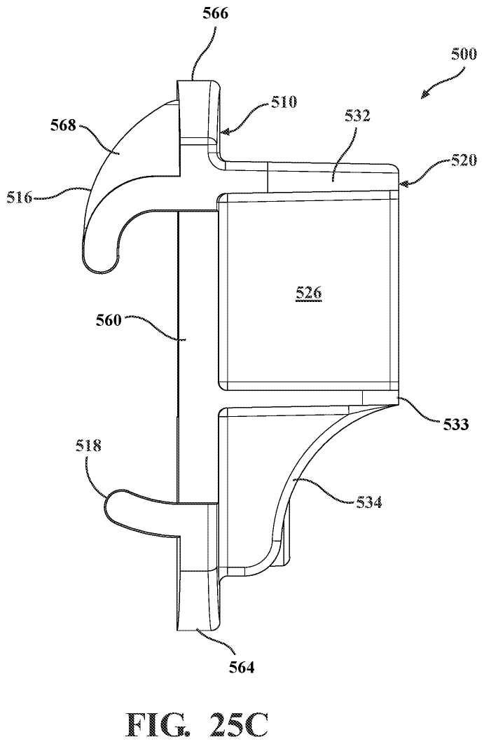

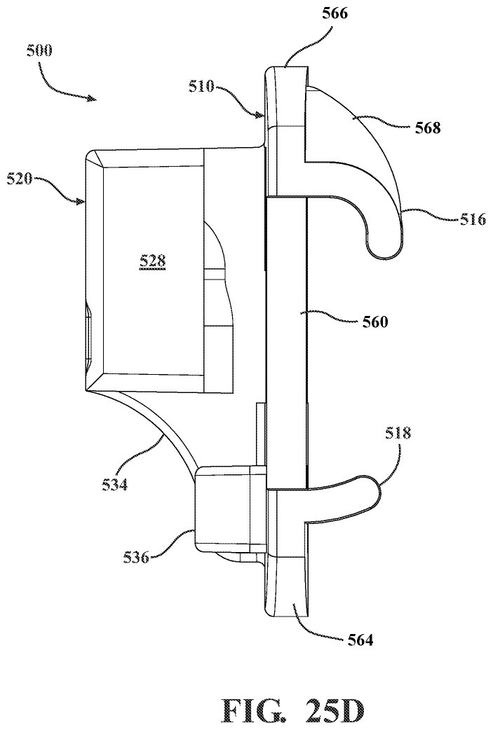

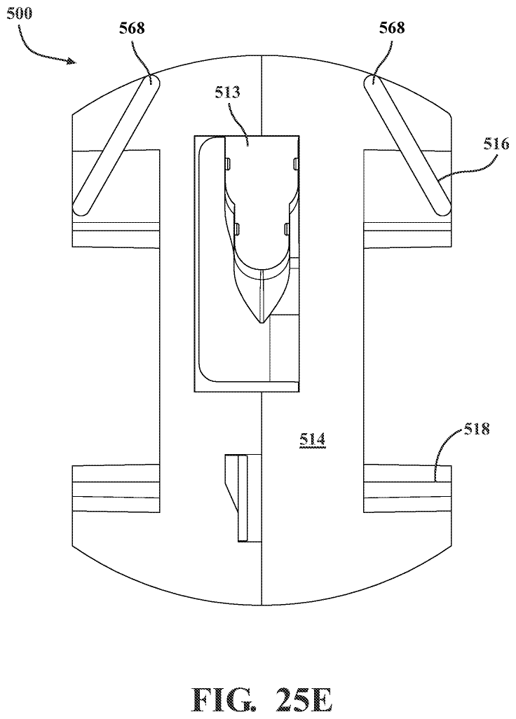

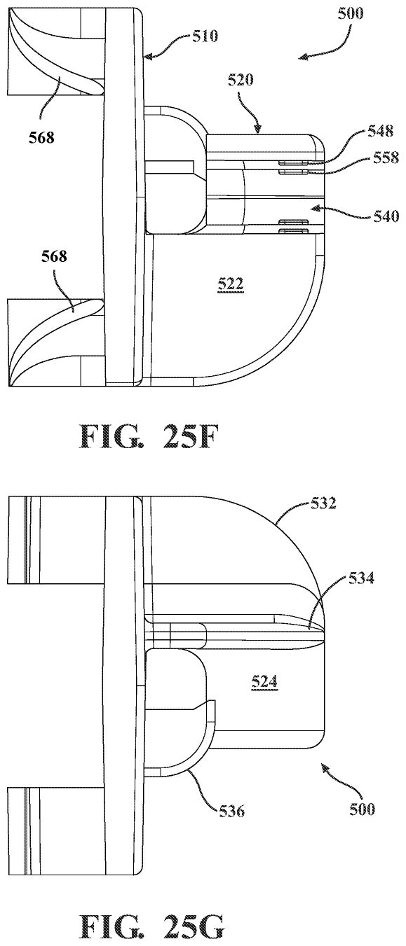

Referring to FIGS. 25A-25G, a bracket 500 configured to support the hanger 10 at the display unit includes a retainer 510 and a coupler 520 at a front surface 512 of the retainer 510. When the retainer 510 is positioned at the display unit like a wire grid wall, a first or upper retaining feature or hook 516 of the retainer 510 receives or wraps around a first, higher horizontal wire or rod and a second or lower retaining feature or hook 518 of the retainer 510 receives or wraps around a second, lower horizontal wire or rod. In the illustrated example, the upper retaining feature 516 includes a pair of hooks extending along opposing lateral sides of the retainer 510 and at an upper edge or top portion 566 of the retainer 510. Similarly, the lower retaining feature 518 includes a pair of hooks extending along opposing lateral sides of the retainer 510 and at a lower edge or bottom portion 564 of the retainer 510. The upper retaining feature 516 and the lower retaining feature 518 may extend from or away from a rear surface 514 of the retainer 510, with the coupler 520 disposed along the front surface 512 of the retainer 510 between the upper retaining feature 516 and the lower retaining feature 518. Angled or canted support flanges or buttresses 568 extend between the respective hooks of the upper retaining feature 516 and the rear surface 514 of the retainer 510.

The coupler 520 includes a socket 540 that is configured to support the peg hook or hanger 10 at the display unit. For example, the coupler 520 includes a first channel or receptacle 542 that extends from a top side 522 of the coupler 520, and a second channel or receptacle 552 that extends from the first channel 542 toward a bottom side 524 of the coupler 520. In the illustrated example, the second channel 552 is narrower than the first channel 542 so that a hanger 10 having a greater thickness or gauge is supported within the first channel 542 and a hanger 10 having a lesser thickness or gauge is supported within the second channel 552. Further, first retaining features 548 are disposed along the first channel 542 and second retaining features 558 are disposed along the second channel 552 to engage the hanger 10 when the hanger 10 is disposed in the respective first channel 542 or second channel 552. The first retaining features 548 or second retaining features 558 flex or compress between the hanger 10 and the respective first channel 542 or second channel 552 to retain the hanger 10 within the socket 540 of the coupler 520.

Moreover, the coupler 520 is configured to allow for selective removal and installation of the hanger at the socket 540. For example, a series of channels or slots separate portions of the coupler 520 and the retainer 510 so that the hanger 10 may be guided along or through the channels when positioning the hanger 10 at the bracket 500. The coupler 520 is attached to or integrally formed with the retainer 510 along a first side 526 of the coupler 520, while a second side 528 opposite the first side 526 is spaced from or separated from the front surface 512 of the retainer 510 to allow the hanger 10 to be moved in and out of alignment with the socket 540. An indentation or passage or recess 513 is formed at least partially through the front surface 512 of the retainer 510 and behind the coupler 520, such as to provide clearance for the hanger 10 during installation and removal of the hanger 10.

The first side 526 of the coupler 520 includes a connecting portion 530 that extends along the first side 526 and that connects the coupler 520 to the front surface 512 of the retainer 510. In the illustrated example, the connecting portion 530 includes a first connecting rib or fin 532 extending between the first side 526 of the coupler 520 and the front surface 512 of the retainer 510. The first connecting rib 532 extends along an upper edge of the first side 526 between a front surface 521 of the coupler 520 and the front surface 512 of the retainer 510. Further, a second connecting rib 533 extends between the first side 526 of the coupler 520 and the front surface 512 of the retainer 510 along a lower edge of the first side 526, and the connecting portion 530 may include any number of connecting ribs along the first side 526 to provide added stability and support for the hanger 10 at the coupler 520. A gusset 534 of the first side 526 extends below the bottom side 524 of the coupler 520 and is attached at the retainer 510 to support the coupler 520. Additionally, a lower wall or abutment 536 extends from the retainer 510 below the coupler 520 and is spaced from the gusset 534 to provide lateral support to the hanger 10 disposed at the coupler 520.

Respective lateral recesses or notches or cutout regions 560 are formed at corresponding positions along the outer lateral edges 562 of the retainer 510 such that the retainer 510 is narrowed at the positions corresponding to the cutout regions 560. In the illustrated example, the cutout regions 560 extend along the retainer 510 and from the first connecting rib 532 of the coupler 520. In the illustrated example, the cutout regions 560 extend along the retainer 510 between the lower retaining feature 518 and the first connecting rib 532 of the coupler 520. Thus, the first connecting rib 532 extends laterally from the coupler 520 and to the outer lateral edge 562 of the retainer 510, with the cutout region 560 extending toward the coupler 520 below the first connecting rib 532 and away from the first connecting rib 532 along the coupler 520 and toward the lower retaining feature 518. The upper retaining feature 516 extends from the rear surface 514 of the retainer 510 at a position that corresponds to the first connecting rib 532, and thus the cutout regions 560 extend along the retainer 510 between the upper retaining feature 516 and the lower retaining feature 518. The second connecting rib 533 extends laterally from the coupler 520 and to the lateral edge of the retainer 510 at the cutout region 560. Thus, the cutout regions 560 reduce the footprint of the retainer 510, such as to reduce weight and materials cost of the bracket 500 and provide clearance for installation of the bracket 500 at the display unit.

Moreover, the retainer 510 may have an at least partially rounded or circular or oval-shaped profile, such as to improve aesthetic of the bracket 500 at the display unit. In other words, the upper edge 566 and the lower edge 564 of the retainer 510 may be rounded or curved. As shown in FIG. 25B, the retainer 510 may thus substantially conform to the footprint of the coupler 520 such that there are not significantly sized portions of the retainer 510 extending beyond the footprint of the coupler 520 and connecting portion 530. This further reduces weight and materials cost for the bracket 500.

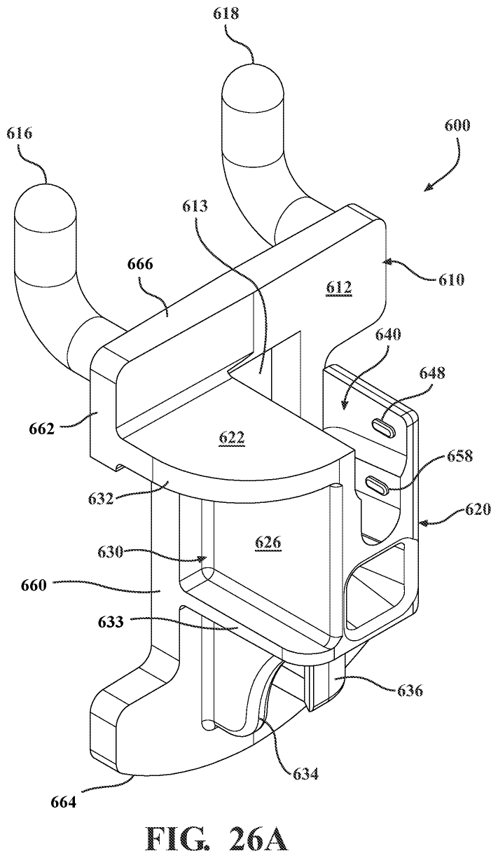

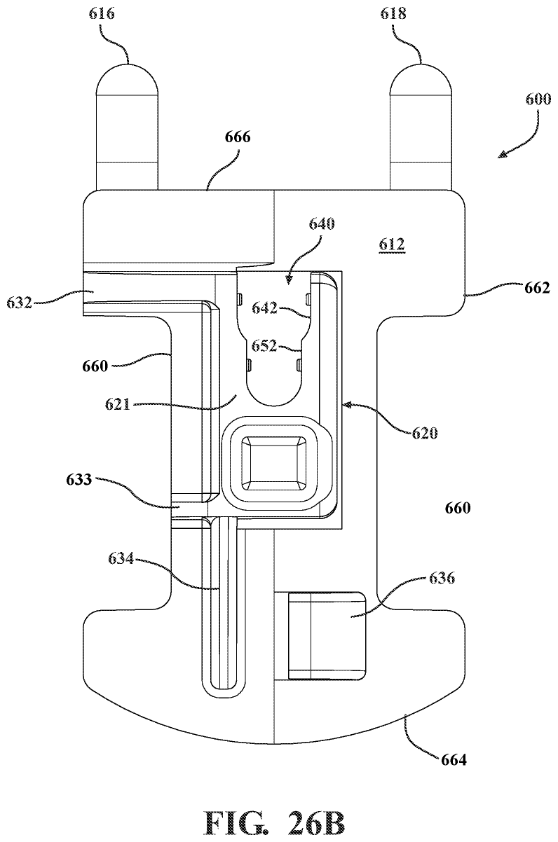

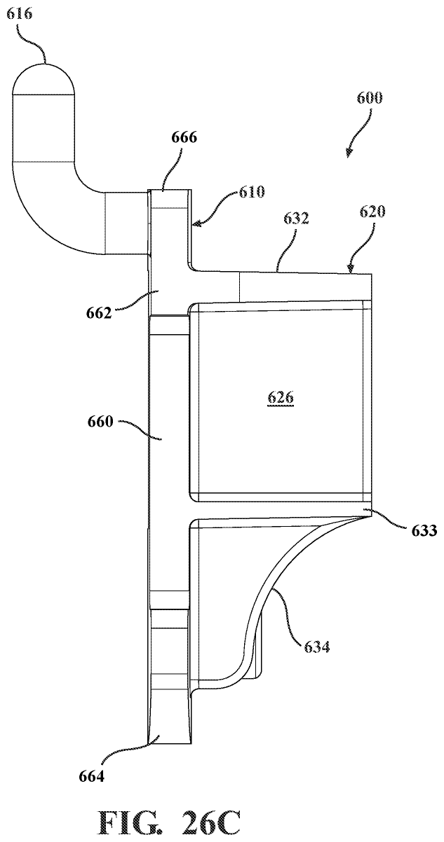

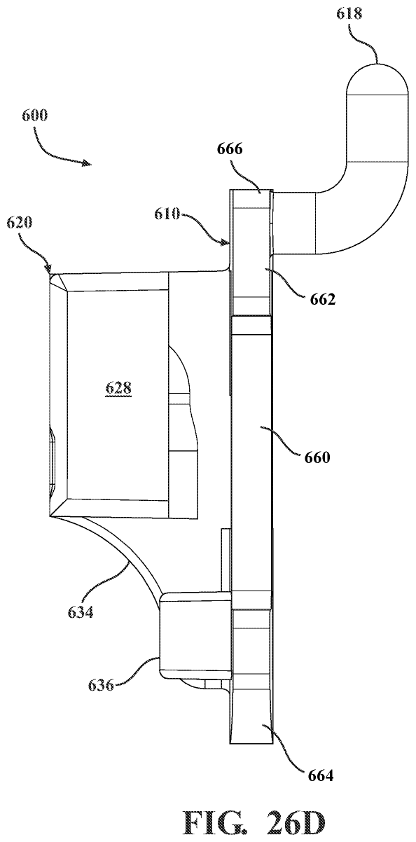

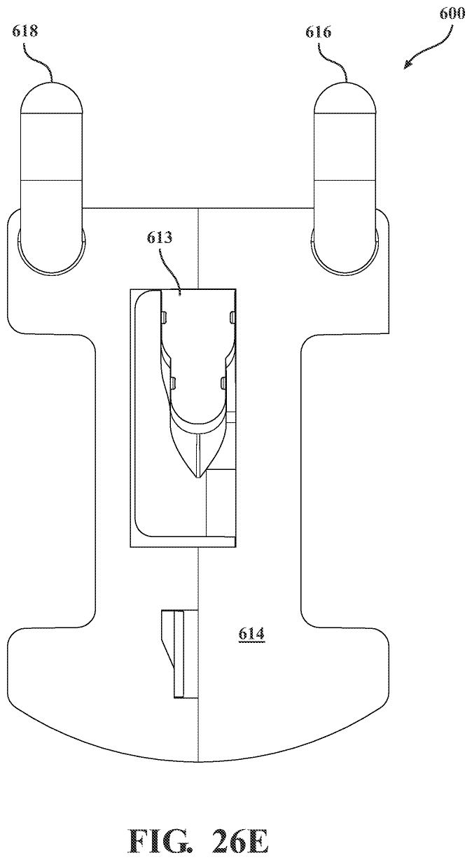

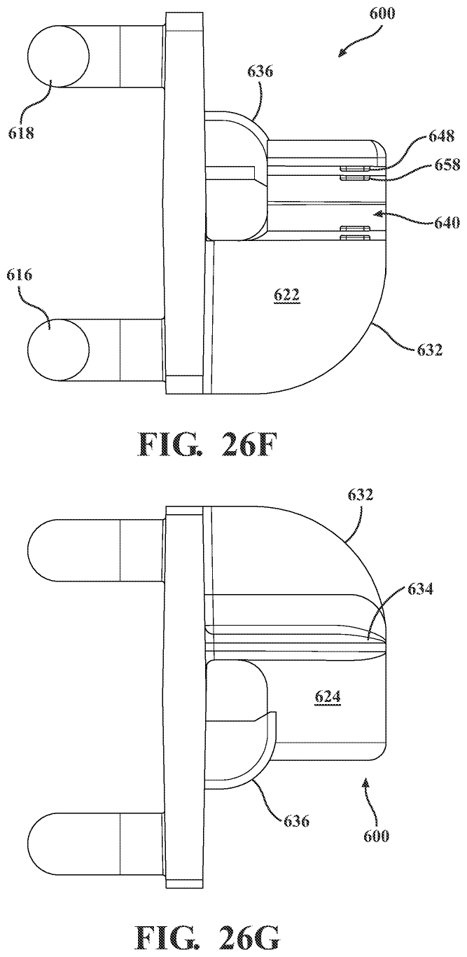

Referring to FIGS. 26A-26G, a bracket 600 configured to support the hanger 10 at the display unit includes a retainer 610 and a coupler 620 at a front surface 612 of the retainer 610. A first retaining feature or hook 616 and a second retaining feature or hook 618 extend from the rear surface 614 of the retainer 610 so that, when the bracket 600 is disposed at a display unit like a peg board, the first hook 616 passes through an aperture of the peg board and the second hook 618 passes through another aperture of the peg board to retain the bracket 600 at the display unit. The first retaining feature 616 and the second retaining feature 618 may extend from or away from the rear surface 614 of the retainer 610, with the coupler 620 disposed along the front surface 612 of the retainer 610.

The coupler 620 includes a socket 640 that is configured to support the peg hook or hanger 10 at the display unit. For example, the coupler 620 includes a first channel or receptacle 642 that extends from a top side 622 of the coupler 620, and a second channel or receptacle 652 that extends from the first channel 642 toward a bottom side 624 of the coupler 620. In the illustrated example, the second channel 652 is narrower than the first channel 642 so that a hanger 10 having a greater thickness or gauge is supported within the first channel 642 and a hanger 10 having a lesser thickness or gauge is supported within the second channel 652. Further, first retaining features 648 are disposed along the first channel 642 and second retaining features 658 are disposed along the second channel 652 to engage the hanger 10 when the hanger 10 is disposed in the respective first channel 642 or second channel 652. The first retaining features 648 or second retaining features 658 flex or compress between the hanger 10 and the respective first channel 642 or second channel 652 to retain the hanger 10 within the socket 640 of the coupler 620.

Moreover, the coupler 620 is configured to allow for selective removal and installation of the hanger at the socket 640. For example, a series of channels or slots separate portions of the coupler 620 and the retainer 610 so that the hanger 10 may be guided along or through the channels when positioning the hanger 10 at the bracket 600. The coupler 620 is attached to or integrally formed with the retainer 610 along a first side 626 of the coupler 620, while a second side 628 opposite the first side 626 is spaced from or separated from the front surface 612 of the retainer 610 to allow the hanger 10 to be moved in and out of alignment with the socket 640. An indentation or passage or recess 613 is formed at least partially through the front surface 612 of the retainer 610 and behind the coupler 620, such as to provide clearance for the hanger 10 during installation and removal of the hanger 10.

The first side 626 of the coupler 620 includes a connecting portion 630 that extends along the first side 626 and that connects the coupler 620 to the front surface 612 of the retainer 610. In the illustrated example, the connecting portion 630 includes a first connecting rib or fin 632 extending between the first side 626 of the coupler 620 and the front surface 612 of the retainer 610. The first connecting rib 632 extends along an upper edge of the first side 626 between a front surface 621 of the coupler 620 and the front surface 612 of the retainer 610. Further, a second connecting rib 633 extends between the first side 626 of the coupler 620 and the front surface 612 of the retainer 610 along a lower edge of the first side 626, and the connecting portion 630 may include any number of connecting ribs along the first side 626 to provide added stability and support for the hanger 10 at the coupler 620. A gusset 634 of the first side 626 extends below the bottom side 624 of the coupler 620 and is attached at the retainer 610 to support the coupler 620. Additionally, a lower wall or abutment 636 extends from the retainer 610 below the coupler 620 and is spaced from the gusset 634 to provide lateral support to the hanger 10 disposed at the coupler 620.

Respective lateral recesses or notches or cutout regions 660 are formed at corresponding positions along the outer lateral edges 662 of the retainer 610 such that the retainer 610 is narrowed at the positions corresponding to the cutout regions 660. In the illustrated example, the cutout regions 660 extend along the retainer 610 and from the first connecting rib 632 of the coupler 620. In the illustrated example, the cutout regions 660 extend along the retainer 610 between the first connecting rib 632 and a lower edge region 664 of the coupler 620. Thus, the first connecting rib 632 extends laterally from the coupler 620 and to the outer lateral edge 662 of the retainer 610, with the cutout region 660 extending toward the coupler 620 below the first connecting rib 632 and away from the first connecting rib 632 along the coupler 620 and toward the lower edge region 664. The cutout regions 660 terminate above the lower edge region 664. Thus, the cutout regions 660 reduce the footprint of the retainer 610, such as to reduce weight and materials cost of the bracket 600 and provide clearance for installation of the bracket 600 at the display unit.

Moreover, the retainer 610 may have an at least partially rounded or circular or oval-shaped profile, such as to improve aesthetic of the bracket 600 at the display unit. In other words, at least one of the upper edge 666 and the lower edge 664 of the retainer 610 may be rounded or curved. In the illustrated example, only the lower edge 664 of the retainer 610 is rounded. As shown in FIG. 26B, the retainer 610 may thus substantially conform to the footprint of the coupler 620 such that there are not significantly sized portions of the retainer 610 extending beyond the footprint of the coupler 620 and connecting portion 630. This further reduces weight and materials cost for the bracket 600.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. Accordingly, other implementations are within the scope of the following claims.

What is claimed is:

1. A bracket for a display unit, the bracket comprising:
a retainer including a front surface and operable to selectively interface with a display unit; and
a coupler attached to the front surface of the retainer and including a socket, the socket having:
a first receptacle defining a first width; and
a second receptacle defining a second width different than the first width.

2. The bracket of claim 1, wherein:
the coupler includes a top side and a bottom side disposed on an opposite side from the top side; and
the socket extends from the top side of the coupler.

3. The bracket of claim 2, wherein:
the first receptacle extends from an opening in the top side of the coupler; and
the second receptacle extends from the first receptacle.

4. The bracket of claim 3, wherein the first width is greater than the second width.

5. The bracket of claim 2, wherein the coupler includes:
a first side attached to the front surface of the retainer; and
an opposite second side spaced apart from the front surface of the retainer by a first channel extending from the top side to the bottom side.

6. The bracket of claim 5, further comprising a slot extending from the bottom side of the coupler and aligned with the socket.

7. The bracket of claim 6, wherein the slot is defined by a first lower wall and a second lower wall disposed adjacent to the bottom side of the coupler.

8. The bracket of claim 7, wherein the lower first wall is spaced apart from the bottom side of the coupler on the first side to define a second channel.

9. The bracket of claim 6, wherein the coupler is configured to receive a hanger, the hanger comprising:
an upper arm that, with the hanger received at the coupler, extends along the socket of the coupler;
a lower arm that, with the hanger received at the coupler; extends below the bottom side of the coupler; and
a connecting arm between the upper arm and the lower arm that, with the hanger received at the coupler, extends along the first channel and the slot.

10. A bracket for a display unit, the bracket comprising:
a retainer including a front surface and operable to selectively interface with a display unit; and
a coupler attached to the retainer and having:
a bottom side;
a top side opposite the bottom side, the top side including an opening and a first receptacle extending from the opening toward the bottom side and defining a first width, and a second receptacle extending from the first receptacle toward the bottom side and defining a second width less than the first width;
a first side attached to the front surface of the retainer, a lower portion of the first side extending below the bottom side of the coupler;
a second side opposite the first side and spaced from the front surface of the retainer by a first channel extending from the top side of the coupler to the bottom side of the coupler; and
an abutment spaced from the bottom side by a second channel.

11. The bracket of claim 10, wherein the coupler is configured to receive a hanger, the hanger comprising:
an upper arm that, with the hanger received at the coupler, extends along one of the first receptacle or the second receptacle;
a lower arm that, with the hanger received at the coupler, extends below the bottom side; and
a connecting arm between the upper arm and the lower arm that, with the hanger received at the coupler, extends along the first channel and between the abutment and the lower portion of the first side.

12. The bracket of claim 11, wherein:
the upper arm of the hanger defines a width that is greater than the second width and less than or equal to the first width; and
the upper arm of the hanger extends along the first receptacle.

13. The bracket of claim 11, wherein:
the upper arm of the hanger defines a width that is less than or equal to the second width; and
the upper arm of the hanger extends along the second receptacle.

14. The bracket of claim 10, wherein the first receptacle and the second receptacle are connected.

15. The bracket of claim 10, wherein the first receptacle includes a first set of protrusions extending from opposing side surfaces of the first receptacle, and the second receptacle includes a second set of protrusions extending from opposing side surfaces of the second receptacle.

16. The bracket of claim 10, wherein the abutment cooperates with the lower portion of the first side to define a third channel aligned with and vertically spaced from the first receptacle and the second receptacle.

17. A bracket for a display unit, the bracket comprising:
a retainer including a front surface and operable to selectively interface with a display unit;
a coupler including a first side attached to the front surface of the retainer, an opposite second side attached to the retainer, and a socket disposed between the first side and the second side and defining a first receptacle; and
a first channel formed through the retainer and connecting to the socket of the coupler between the first side and the second side.

18. The bracket of claim 17, wherein the socket is formed in a top side of the coupler.

19. The bracket of claim 17, wherein the first channel extends continuously from a top side of the coupler to a bottom side of the coupler.

20. The bracket of claim 17, wherein each of the first side of the coupler and the second side of the coupler is arcuate.
